(19) United States
(12) Patent Application Publication
(10) Pub. No.: US 2014/0071379 A1
(43) Pub. Date: Mar. 13, 2014

(54) POLARIZING PLATE PROTECTIVE FILM, POLARIZING PLATE, AND LIQUID CRYSTAL DISPLAY DEVICE

(71) Applicant: KONICA MINOLTA, INC., Tokyo (JP)

(72) Inventors: Naoki TAKAHASHI, Hyogo (JP); Takashi TAKEBE, Tokyo (JP); Satoshi MORII, Tokyo (JP); Kazuki AKASAKA, Tokyo (JP); Nobuo KUBO, Tokyo (JP)

(73) Assignee: KONICA MINOLTA, INC., Tokyo (JP)

(21) Appl. No.: 14/081,747

(22) Filed: Nov. 15, 2013

Related U.S. Application Data
(63) Continuation-in-part of application No. PCT/JP2012/003244, filed on May 17, 2012.

(30) Foreign Application Priority Data
May 18, 2011 (JP) 2011-111803

(51) Int. Cl. G02F 1/1335; G02B 5/30

(52) U.S. Cl. CPC G02F 1/13362; G02B 5/3083
USPC 349/62; 359/489.01

(57) ABSTRACT

The purpose of the present invention is to provide a polarizing plate protective film and liquid crystal display device comprising same whereby the generation of egg-shaped blur in a liquid crystal display device (especially an IPS liquid crystal display device) can still be limited even under high-temperature/high-humidity conditions. For this polarizing plate protective film, if nx is the refractive index in the X-axis direction at which the birefringence in the film surface reaches a maximum and ny is the refractive index in the Y-axis direction orthogonal to the X-axis direction in the film surface, then the birefringence under stress (nx−ny) of the film as measured at a wavelength of 589 nm when any tensile stress 5-35 MPa is applied in the X-axis direction or Y-axis direction of the film under 50 DEG C, 80% RH conditions is 0.

### TECHNICAL FIELD

The present invention relates to a polarizer protective film, a polarizing plate, and a liquid crystal display device.

### BACKGROUND ART

Liquid crystal display devices have been widely used in recent years because of their flat panels and light weights as well as low power consumption. The liquid crystal display device typically has a liquid crystal cell and first and second polarizing plates between which the liquid crystal cell is sandwiched. The first polarizing plate has a first polarizer and a pair of polarizer protective films F1 and F2 between which the first polarizer is sandwiched. The second polarizing plate has a second polarizer and a pair of polarizer protective films F3 and F4 between which the second polarizer is sandwiched. The polarizer protective films F1, F2, F3, and F4 are disposed in the order named.

The polarizer protective film may be desired to be optically isotropic, depending on the type of the liquid crystal cell. For this purpose, a polarizer protective film having reduced orientation birefringence or a reduced photoelastic coefficient has been proposed (e.g., PTL 1).

With advances in liquid crystal display devices, light leakage (unevenness) has been ameliorated. Conventional methods, however, may fail to sufficiently ameliorate the light leakage in recent liquid crystal display devices with larger screens and flatter panels. Particularly, IPS-type liquid crystal display devices are known to generate circular blur, called egg-shaped blur, at the center of their display screens when stored in a hot and humid environment (see e.g., PTL 2).

### CITATION LIST

### Patent Literature

PTL 1: Japanese Patent Application Laid-Open No. 2004-339406
PTL 2: WO2008/016242

### SUMMARY OF INVENTION

### Technical Problem

Egg-shaped blur is generally thought to occur due to birefringence generated under stress concentrated on a polarizer protective film disposed in contact with the liquid crystal cell as a result of contraction or expansion of the polarizer caused by change in the usage environment of the liquid crystal display device. Particularly, the IPS-type liquid crystal display device disadvantageously has more conspicuous egg-shaped blur due to birefringence generated in the polarizer protective film.

For preventing birefringence from being generated even under concentrated stress, it is required to decrease the absolute value of the photoelastic coefficient of the polarizer protective film. However, the photoelastic coefficient depends on temperature and humidity and therefore easily varies depending on the usage environment of the liquid crystal display device. The usage environment of the liquid crystal display device always changes due to the heat of the backlight, ambient temperature or humidity, and the like. No existing film therefore takes a photoelastic coefficient of 0 any time in any usage environment. Thus, even a polarizer protective film having a small absolute value of a photoelastic coefficient at ordinary temperature may not have a sufficiently small absolute value of a photoelastic coefficient in hot and humid conditions. The resulting liquid crystal display device produces undesired egg-shaped blur in the display screen when used in hot and humid conditions.

The present invention has been made in consideration of these circumstances, and an object of the present invention is to provide a polarizer protective film capable of limiting the generation of egg-shaped blur in a liquid crystal display device (particularly, an IPS-type liquid crystal display device) even under hot and humid conditions, and a liquid crystal display device including the same.

### Solution to Problem

[1] A polarizer protective film having a birefringence (nx−ny) under stress of 0, where nx represents a refractive index in X-axis direction in which an in-plane birefringence of the film is maximized, and ny represents a refractive index in Y-axis direction orthogonally intersecting the X-axis direction in the plane of the film,

wherein the birefringence (nx−ny) under stress is measured at a wavelength of 589 nm under any tensile stress of 5 MPa to 35 MPa applied in the X-axis direction or the Y-axis direction of the film under conditions of 50° C. and 80% RH.

[2] The polarizer protective film according to [1], wherein under conditions of 50° C. and 80% RH in the absence of tensile stress, the film has in-plane retardation R₀(589) in the range of −3 nm to +3 nm at a wavelength of 589 nm and thickness retardation Rt(589) in the range of −3 nm to +3 nm at a wavelength of 589 nm, the in-plane retardation R₀(589) and the thickness retardation Rt(589) being represented by Equations (I) and (II), respectively:

R₀(589)=(nx−ny)×d, Equation (I):

and

Rt(589)={(nx+ny)/2−nz}×d, Equation (II):

where d represents a thickness (nm) of the film; nx represents a refractive index in the X-axis direction in which the in-plane birefringence of the film is maximized; ny represents a refractive index in the Y-axis direction orthogonally intersecting the X-axis in the plane of the film; and nz represents a refractive index in a thickness direction of the film.

[3] The polarizer protective film according to [1] or [2], wherein the film has a photoelastic coefficient of −3.0×10⁻¹² to 3.0×10⁻¹² m²/N under conditions of 50° C. and 80% RH.

[4] The polarizer protective film according to any of [1] to [3], wherein the film has a birefringence (nx−ny) under stress of 0, the birefringence (nx−ny) under stress being measured at a wavelength of 589 nm under any tensile stress of 5 MPa to 35 MPa applied in the X-axis direction or the Y-axis direction of the film under conditions of 23° C. and 55% RH.

[5] The polarizer protective film according to any of [1] to [4], iwherein the film comprises an acrylic resin and a cellulose ester.

[6] The polarizer protective film according to [5], wherein a mass ratio of the acrylic resin and to the cellulose ester (acrylic resin/cellulose ester) is 90/10 to 30/70.

[7] The polarizer protective film according to [5] or [6], wherein the cellulose ester has a total degree of acyl substitution of 2 to 3 and a degree of C₃₋₇ acyl substitution of 2 to 3.

[8] A polarizing plate including:

a polarizer; and

the polarizer protective film according to any of [1] to [7] disposed on at least one surface of the polarizer.

[9] A liquid crystal display device comprising, in order from the viewing side:

a first polarizing plate;

a liquid crystal cell;

a second polarizing plate; and

a backlight,

wherein the liquid crystal cell includes first and second opposing substrates, the first substrate having a pixel electrode and a counter electrode disposed thereon, and a liquid crystal layer sandwiched between the first and second substrates, the liquid crystal layer including liquid crystal molecules oriented horizontally to a surface of the first substrate during voltage is not applied,

the first polarizing plate includes a first polarizer and a polarizer protective film F2 disposed on a surface on a liquid crystal cell side of the first polarizer,

the second polarizing plate includes a second polarizer and a polarizer protective film F3 disposed on a surface on the liquid crystal cell side of the second polarizer, and at least one of the polarizer protective films F2 and F3 is the polarizer protective film according to any one of [1] to [4].

[10] The liquid crystal display device according to [9], wherein at least one of the polarizer protective films F2 and F3 is the polarizer protective film according to any of [5] to [7].

[11] The liquid crystal display device according to [9], wherein at least one of the polarizer protective films F2 and F3 includes a lactone ring-containing polymer.

[12] The liquid crystal display device according to [9], wherein the polarizer protective film F3 is the polarizer protective film according to any of [5] to [7].

[13] The liquid crystal display device according to [9], wherein the polarizer protective film F3 includes a lactone ring-containing polymer.

### Advantageous Effects of Invention

The present invention can provide a liquid crystal display device (particularly, an IPS-type liquid crystal display device) wherein the generation of egg-shaped blur is limited even under hot and humid conditions.

### BRIEF DESCRIPTION OF DRAWING

FIG. 1 schematically illustrates a basic structure according to an embodiment of the liquid crystal display device of the present invention.

### DESCRIPTION OF EMBODIMENTS

A liquid crystal display device of the present invention has a liquid crystal cell, a pair of polarizing plates between which the liquid crystal cell is sandwiched, and a backlight.

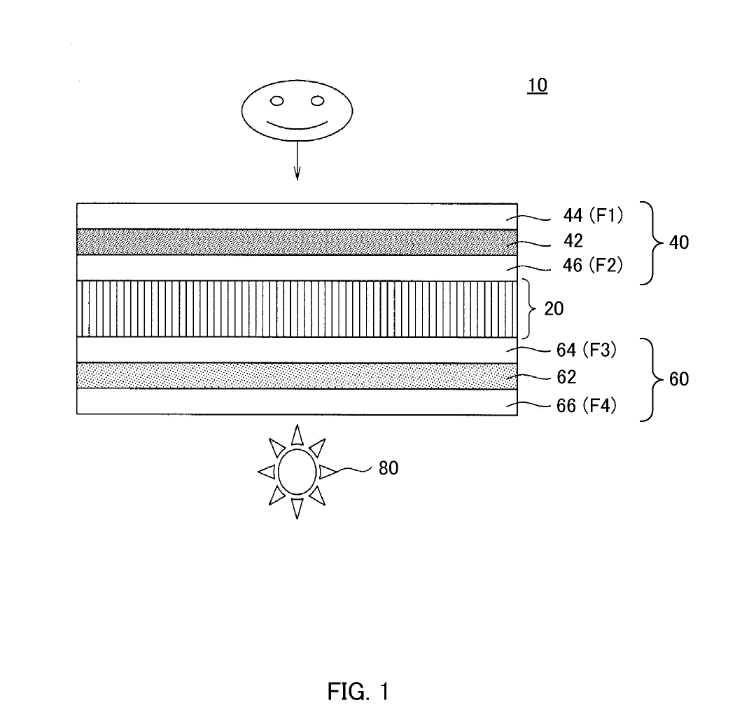

FIG. 1 schematically illustrates a basic structure according to an embodiment of the liquid crystal display device of the present invention. As illustrated in FIG. 1, liquid crystal display device 10 has liquid crystal cell 20, first polarizing plate 40 and second polarizing plate 60 between which the liquid crystal cell is sandwiched, and backlight 80.

First Polarizing Plate 40 and Second Polarizing Plate 60

First polarizing plate 40 is disposed on the viewing side of liquid crystal cell 20 and has first polarizer 42 and polarizer protective films 44 (F1) and 46 (F2) between which the first polarizer is sandwiched. Second polarizing plate 60 is disposed on the backlight 80 side of liquid crystal cell 20 and has second polarizer 62 and polarizer protective films 64 (F3) and 66 (F4) between which the second polarizer is sandwiched. Polarizer protective films 44 (F1), 46 (F2), 64 (F3), and 66 (F4) are disposed in the order named from the viewing side.

The polarizer constituting each polarizing plate is an element that permits mere passage of light polarized in a single plane. Typical examples of the polarizer include stretched polyvinyl alcohol films stained with dichroic dyes typified by polyiodide and the like.

The polarizer may be a polyvinyl alcohol-based film uniaxially stretched and then stained with a dichroic dye such as polyiodide or may be a polyvinyl alcohol-based film stained with a dichroic dye such as polyiodide and then uniaxially stretched (preferably, further treated with a boron compound in order to impart durability to the film). The stretch ratio for the uniaxial stretching can be set to approximately 4 to 8 times. The polarizer has a thickness of preferably 5 to 30 μm, more preferably 10 to 25 μm. Preferably, first polarizer 42 and second polarizer 62 have the same stretch ratios and the same thicknesses.

The polyvinyl alcohol-based film may be a film formed from an aqueous polyvinyl alcohol solution. The polyvinyl alcohol-based film is preferably an ethylene-modified polyvinyl alcohol film, for example, because this film is excellent in polarization performance and durability and exhibits reduced color unevenness. Examples of the ethylene-modified polyvinyl alcohol film include films having an ethylene unit content of 1 to 4 mol %, a degree of polymerization of 2000 to 4000, and a degree of saponification of 99.0 to 99.99 mol % as disclosed in, for example, Japanese Patent Application Laid-Open Nos. 2003-248123 and 2003-342322.

Examples of the dichroic dye include the polyiodide mentioned above as well as azo-based dyes, stilbene-based dyes, pyrazolone-based dyes, triphenylmethane-based dyes, quinoline-based dyes, oxazine-based dyes, thiazine-based dyes, and anthraquinone-based dyes.

Of polarizer protective films 44 (F1), 46 (F2), 64 (F3), and 66 (F4), mainly, polarizer protective films 46 (F2) and 64 (F3) may adjust the optical properties of the liquid crystal display device. Hereinafter, each polarizer protective film will be described.

Polarizer Protective Films 46 (F2) or 64 (F3)

For limiting the generation of egg-shaped blur in the display apparatus under hot and humid conditions, it is important that at least one of polarizer protective films 46 (F2) and 64 (F3) have a birefringence under stress of 0, with a predetermined stress applied thereto under hot and humid conditions. The stress to be applied to the polarizer protective film under hot and humid conditions is considered to be mainly a contraction stress of the polarizer, a stress that is applied to the polarizing plate along with the deformation of the backlight unit, or the like.

A feature of the polarizer protective film of the present invention is therefore to have a birefringence (nx−ny) (where nx is a refractive index in X-axis direction, and ny is a refractive index in Y-axis direction) under stress of 0, wherein X-axis is defined as a direction in which the in-plane birefringence of the film is maximized, Y-axis is defined as a direction orthogonally intersecting the X-axis in the plane of the film, and the birefringence (nx−ny) under stress is measured under any tensile stress in the range of 5 MPa to 35 MPa applied in the X-axis direction or the Y-axis direction of the film under conditions of 50° C. and 80% RH. Birefringence under stress is defined as the sum of orientation birefringence and stress birefringence. Orientation birefringence refers to birefringence in a state free from stress. Stress birefringence refers to an increment or decrement of the birefringence generated by application of stress. More preferably, the polarizer protective film of the present invention has a birefringence (nx−ny) under stress of 0 under any stress in the range of 5 MPa to 25 MPa under conditions of 50° C. and 80% RH.

Even more preferably, the polarizer protective film of the present invention has a birefringence (nx−ny) under stress of 0 under any stress in the range of 5 MPa to 35 MPa, further preferably under any stress in the range of 5 MPa to 25 MPa, even under conditions of 23° C. and 55% RH.

The birefringence (nx−ny) under stress of the film can be measured by the following procedures:

1) The in-plane retardation R₀(589) of the polarizer protective film at a wavelength of 589 nm is measured using a retardation meter (KOBRA 31PR, manufactured by Oji Scientific Instruments) under tensile load applied in the X-axis direction or the Y-axis direction of the film under conditions of 50° C. and 80% RH. The in-plane retardation R₀(589) of the polarizer protective film at a wavelength of 589 nm is measured while the tensile load applied to the film is increased in stages.

2) Then, the tensile load under which the in-plane retardation R₀(589) of the film becomes 0 is measured. The obtained tensile load is determined as the “tensile stress under which birefringence (nx−ny) becomes 0”. The measurement can be performed under conditions of 50° C. and 80% RH or under conditions of 23° C. and 55% RH.

The relationship between tensile stress N applied to the film and birefringence Δn (=nx−ny) under stress of the film is approximated to a straight line (Δn=cN+d, where c: a photoelastic coefficient, and d: Δn in the absence of stress (birefringence in a state free from stress)) in a graph with the tensile stress as an abscissa and the birefringence Δn under stress of the film as an ordinate. The tensile stress under which the film has a birefringence (nx−ny) of 0 can therefore be adjusted, as mentioned later, by Δn in the absence of stress or photoelastic coefficient c of the film. Δn in the absence of stress can be adjusted, as mentioned later, by in-plane retardation R₀ in the absence of stress. The in-plane retardation R₀ can be adjusted by film stretching conditions, etc. The photoelastic coefficient c of the film can be adjusted, as mentioned later, by the mixing ratio between an acrylic resin (A) having a negative photoelastic coefficient and a cellulose ester resin (B) having a positive photoelastic coefficient, the degree of C₃₋₇ acyl substitution in the cellulose ester resin (B), etc.

For stably limiting the generation of egg-shaped blur, it is important that the birefringence (nx−ny) under stress of the film should be kept at or near 0 even when the tensile stress to be applied to the polarizer protective film varies to some extent within the range described above. Preferably, the film therefore has the minimum photoelastic coefficient c.

Specifically, the film has photoelastic coefficient c of preferably −3.0×10⁻¹² to 3.0×10⁻¹² m²/N, more preferably −1.5×10¹² to 1.5×10⁻¹² m²/N, the photoelastic coefficient being measured under conditions of 50° C. and 80% RH. The photoelastic coefficient c of the film can be adjusted, as mentioned later, by the mixing ratio between an acrylic resin (A) having a negative photoelastic coefficient c and a cellulose ester resin (B) having a positive photoelastic coefficient c, the degree of C₃₋₇ acyl substitution in the cellulose ester resin (B), etc.

The photoelastic coefficient c of the film can be measured by the following procedures:

In the measurement of the birefringence (nx−ny) of the film under stress applied thereto as mentioned above, Δn measured under each tensile stress is plotted against the tensile stress applied to the film as an abscissa and Δn (which is obtained by dividing the in-plane retardation R₀(589) of the film by film thickness d) as an ordinate to obtain a plot of Δn versus tensile load. When the obtained plot is approximated to a straight line, the slope of the straight line is determined as photoelastic coefficient c. The measurement can be performed under conditions of 50° C. and 80% RH or under conditions of 23° C. and 55% RH.

The in-plane retardation R₀(589) of the polarizer protective film in the absence of stress is set according to the display system of the liquid crystal cell or the desired optical functions. For example, the in-plane retardation R₀(589) of the polarizer protective film that is combined with an IPS-type liquid crystal cell is preferably in the range of −3 nm to +3 nm, more preferably in the range of −2 nm to +2 nm. The thickness retardation Rt(589) of the polarizer protective film is also preferably in the range of −3 nm to +3 nm, more preferably −2 nm to +2 nm. The in-plane retardation R₀(589) and the thickness retardation Rt(589) can be adjusted, as mentioned later, by film stretching conditions, etc.

Retardations R₀ and Rt are found by the following equations:

R₀=(nx−ny)×d,

and

Rt={(nx+ny)/2−nz}×d

where d represents a film thickness (nm); nx represents a refractive index in X-axis direction in which the in-plane birefringence of the film is maximized; ny represents a refractive index in Y-axis direction orthogonally intersecting the X-axis in the plane of the film; and nz represents a refractive index in the thickness direction of the film.

Retardations R₀ and Rt can be determined by any of the methods known in the art, for example, as follows:

1) The average refractive index of the film is measured using a refractometer.

2) In-plane retardation R₀ is measured with light (wavelength: 589 nm) incident from the film normal direction using KOBRA 31 WR manufactured by Oji Scientific Instruments.

3) Retardation value R(θ) is measured with light (wavelength: 589 nm) incident at an angle of θ (incident angle (θ)) relative to the film normal direction using KOBRA 31WR manufactured by Oji Scientific Instruments. The angle θ is larger than 0° and is preferably 30° to 50°.

4) From the measured R₀ and R(O), the average refractive index, and the thickness of the film as mentioned above, nx, ny, and nz are calculated using KOBRA 31 WR manufactured by Oji Scientific Instruments. Thus, Rt can be calculated. The retardation measurement can be performed under conditions of 50° C. and 80% RH or under conditions of 23° C. and 55% RH.

The polarizer protective film of the present invention contains a mixture of an acrylic resin (A) and a cellulose ester resin (B), or a lactone ring-containing polymer.

Mixture of acrylic resin (A) and cellulose ester resin (B)

Acrylic Resin(A)

The acrylic resin (A) contained in the polarizer protective film of the present invention can be a (meth)acrylic acid ester homopolymer or a copolymer of (meth)acrylic acid ester and an additional copolymerizable monomer. The (meth)acrylic acid ester in the copolymer is preferably methyl(meth)acrylate. Preferably, the copolymer has 50 to 99% constitutional units derived from the methyl(meth)acrylate.

Examples of the additional copolymerizable monomer in the copolymer of methyl (meth)acrylate therewith include: alkyl acrylate having a C₁₋₁₈ alkyl moiety; alkyl methacrylate having a C₂₋₁₈ alkyl moiety; α,β-unsaturated acids such as acrylic acid and methacrylic acid; unsaturated group-containing divalent carboxylic acids such as maleic acid, fumaric acid, and itaconic acid; aromatic vinyl compounds such as styrene and α-methylstyrene; α,β-unsaturated nitriles such as acrylonitrile and methacrylonitrile; and other compounds such as maleic anhydride, maleimide, N-substituted maleimide, and glutaric anhydride. Among them, alkyl acrylate having a C₁₋₁₈ alkyl moiety is preferred, for example, from the viewpoint of enhancing thermal decomposition resistance or flowability of the copolymer.

Examples of the alkyl acrylate having a C₁₋₁₈ alkyl moiety include methyl acrylate, ethyl acrylate, n-propyl acrylate, n-butyl acrylate, s-butyl acrylate, and 2-ethylhexyl acrylate. Methyl acrylate or n-butyl acrylate is preferred. These copolymerizable monomers may be used alone or in combination.

Preferably, the acrylic resin (A) has a weight-average molecular weight (Mw) of 8.0×10⁴ or larger, for example, from the viewpoint of ameliorating the brittleness of the film or enhancing compatibility with the cellulose ester resin (B). An acrylic resin (A) having a weight-average molecular weight (Mw) smaller than 8.0×10⁴ may fail to sufficiently ameliorate the brittleness of the film and also have insufficient compatibility with the cellulose ester resin (B). Preferably, the acrylic resin (A) has a weight-average molecular weight (Mw) of 1.0×10⁶ or smaller from the viewpoint of manufacturing. The weight-average molecular weight (Mw) of the acrylic resin (A) is more preferably in the range of 1.0×10⁵ to 6.0×10⁵, even more preferably in the range of 1.5×10⁵ to 4.0×10⁵.

The weight-average molecular weight Mw of the acrylic resin (A) can be measured by gel permeation chromatography. The measurement conditions are as follows:

Solvent: methylene chloride

Column: Shodex K806, K805, and K803G (three columns manufactured by Showa Denko K.K. were used in connection)

Column temperature: 25° C.

Sample concentration: 0.1 mass %

Detector: RI Model 504 (manufactured by GL Sciences Inc.)

Pump: L6000 (manufactured by Hitachi, Ltd.)

Flow rate: 1.0 ml/min

Calibration curve: standard polystyrene; STK standard polystyrene (manufactured Tosoh Corp.). The calibration curve used was prepared with 13 samples having Mw of 2,800,000 to 500. Preferably, the concentrations of these 13 samples are almost evenly spaced on the calibration curve.

The acrylic resins (A) exemplified above may be used alone or in combination.

The acrylic resin (A) may be produced by any method, for example, suspension polymerization, emulsion polymerization, bulk polymerization, or solution polymerization, or may be a commercially available product. A polymerization initiator may be used in the polymerization reaction. In such a case, usual peroxide-based, azo-based, or redox-based polymerization initiator can be used. The polymerization temperature can be set to 30° C. to 100° C. for suspension polymerization or emulsion polymerization and to 80° C. to 160° C. for bulk polymerization or solution polymerization. A chain transfer agent such as alkylmercaptan may be used in order to adjust the reduced viscosity of the resulting acrylic resin (A).

Examples of the commercially available product of the acrylic resin (A) include Delpet 60N and 80N (manufactured by Asahi Kasei Chemicals Corp.), Dianal BR52, BR80, BR83, BR85, and BR88 (manufactured by Mitsubishi Rayon Co., Ltd.), and KT75 (manufactured by Denki Kagaku Kogyo K.K.).

Cellulose Ester Resin (B)

The cellulose ester resin (B) has an acyl group which may be an aliphatic or aromatic acyl group. The aliphatic acyl group may be linear or branched and may further have a substituent. The number of carbon atoms in the aliphatic acyl group refers to the total number of carbon atoms including the carbon atoms of the substituent.

The aromatic acyl group may further a substituent. In such a case, preferably, 0 to 5 substituents are added to the aromatic ring. The number of carbon atoms in the aromatic acyl group having a substituent refers to the total number of carbon atoms including the carbon atoms of the substituent. Two or more substituents that are added to the aromatic ring may be the same as or different from each other and may be linked together to form a fused polycyclic compound (e.g., naphthalene, indene, indane, phenanthrene, quinoline, isoquinoline, chromene, chromane, phthalazine, acridine, indole, and indoline).

Preferably, the cellulose ester resin (B) contains a C₃₋₇ aliphatic acyl group, more preferably a C₃₄ aliphatic acyl group.

The cellulose ester resin (B) has a total degree of acyl substitution of preferably 2.0 to 3.0, more preferably 2.5 to 3.0, for example, from the viewpoint of ameliorating the brittleness of the film or enhancing compatibility with the acrylic resin. The degree of substitution of C₃₋₇ acyl groups, of all acyl groups, in the cellulose ester resin (B) is preferably 1.2 to 3.0, more preferably 2.0 to 3.0.

Examples of the C₃₋₇ acyl groups include propionyl and butyryl groups. A propionyl group is preferred. The total degree of substitution of acyl groups other than C₃₋₇ acyl groups is preferably 1.3 or lower. Examples of the acyl groups other than C₃₋₇ acyl groups include an acetyl group.

When the cellulose ester resin (B) has a total degree of acyl substitution lower than 2.0, the resin is insufficiently compatible with the acrylic resin (A), and the resulting film may have too large in-plane retardation R₀, which in turn makes it difficult to adjust the stress under which birefringence Δn becomes 0 to within the range described above, or increases haze. By contrast, when cellulose ester resin (B) has a degree of C₃₋₇ acyl substitution lower than 1.2, albeit having a total degree of acyl substitution of 2.0 or higher, the resin is insufficiently compatible with the acrylic resin (A) and, in addition, tends to increase the absolute value of photoelastic coefficient c. Thus, the stress under which birefringence Δn becomes 0 tends to be decreased.

For example, when the cellulose ester resin (B) has a high degree of C₂ acyl (acetyl) substitution and a degree of C₃₋₇ acyl substitution lower than 1.2, although it has a total degree of acyl substitution of 2.0 or higher, the cellulose ester resin (B) is insufficiently compatible with the acrylic resin (A) and may increase the absolute value of photoelastic coefficient c. Thus the stress under which birefringence Δn becomes 0 may be decreased. On the other hand, when the cellulose ester resin (B) has a high degree of C₈ or higher acyl substitution and a degree of C₃₋₇ acyl substitution lower than 1.2, although it has a total degree of acyl substitution of 2.0 or higher, the cellulose ester resin (B) may increase the absolute value of photoelastic coefficient c, resulting in the decreased stress under which birefringence Δn becomes 0.

The degree of acyl substitution of the cellulose ester can be measured according to ASTM-D817-96.

Examples of the cellulose ester resin (B) contained in the polarizer protective film include cellulose acetate propionate, cellulose acetate butyrate, cellulose acetate benzoate, cellulose propionate, and cellulose butyrate. Cellulose acetate propionate or cellulose propionate is preferred.

The cellulose ester resin (B) has a weight-average molecular weight Mw of 75000 or larger, preferably in the range of 75000 to 300000, more preferably in the range of 100000 to 240000, particularly preferably 160000 to 240000, for example, from the viewpoint of enhancing compatibility with the acrylic resin (A) or ameliorating the brittleness of the film A cellulose ester resin (B) having a weight-average molecular weight Mw smaller than 75000 may result in insufficient heat resistance of the film or may be insufficiently effective for ameliorating the brittleness of the film.

The cellulose ester resin (B) has a molecular weight distribution (weight-average molecular weight Mw/number-average molecular weight Mn) of preferably 1.5 to 5.5, more preferably 2.0 to 5.0, even more preferably 2.5 to 5.0.

The molecular weight and the molecular weight distribution of the cellulose ester resin (B) can be measured by high-performance liquid chromatography.

The measurement conditions are as follows:

Solvent: methylene chloride

Column: Shodex K806, K805, and K803G (manufactured by Showa Denko K.K.); these three columns are used in connection.

Column temperature: 25° C.

Sample concentration: 0.1 mass %

Detector: RI Model 504 (manufactured by GL Sciences Inc.)

Pump: L6000 (manufactured by Hitachi, Ltd.)

Flow rate: 1.0 ml/min

Calibration curve: standard polystyrene; STK standard polystyrene (manufactured Tosoh Corp.). The calibration curve used is prepared with 13 samples having Mw of 1.0×10⁶ to 5.0×10². Preferably, these 13 samples are selected so that their concentrations are evenly spaced on the calibration curve.

The cellulose ester resins (B) exemplified above may be used alone or in combination.

The mass ratio of the acrylic resin (A) to the cellulose ester resin (B) (acrylic resin (A)/cellulose ester resin (B)) contained in the polarizer protective film is preferably 95/5 to 30/70, more preferably 95/5 to 50/50, even more preferably 90/10 to 60/40. A proportion of the acrylic resin (A) exceeding 95 mass % with respect to the total of the acrylic resin (A) and the cellulose ester resin (B) may too largely bias photoelastic coefficient c toward the negative. As a result, birefringence (nx−ny) under stress may become 0 under a tensile stress in the range of lower than 5 MPa. By contrast, a proportion of the acrylic resin (A) lower than 30 mass % with respect to the total of the acrylic resin (A) and the cellulose ester resin (B) may too largely bias photoelastic coefficient c toward the positive. As a result, birefringence (nx−ny) under stress may become 0 under a tensile stress in the range of lower than 5 MPa.

The total content of the acrylic resin (A) and the cellulose ester resin (B) in the polarizer protective film is preferably 55 mass % or higher, more preferably 60 mass % or higher, even more preferably 70 mass % or higher, with respect to the whole film.

Preferably, the acrylic resin (A) and the cellulose ester resin (B) contained in the polarizer protective film of the present invention are compatibilized with each other. The “resin in which the acrylic resin (A) and the cellulose ester resin (B) are compatibilized” means a resin having a compatibilized state as a result of mixing these resins (polymers) and excludes a mixed resin obtained by mixing monomers or oligomers constituting the acrylic resin with the cellulose ester resin (B), followed by polymerization. This is because: the step of obtaining such a mixed resin involves complicated polymerization reaction and is difficult to control; and, in addition, the molecular weight of the resulting mixed resin is difficult to adjust. The compatibility between the acrylic resin (A) and the cellulose ester resin (B) can be enhanced, for example, by further mixing other resins therewith.

The compatibilized state of the acrylic resin (A) and the cellulose ester resin (B) can be confirmed, for example, on the basis of glass transition temperature Tg of the polarizer protective film. For example, a film in which the acrylic resin (A) and the cellulose ester resin (B), which differ in their glass transition temperatures, are not compatibilized has two glass transition temperatures unique to the respective resins. On the other hand, a film in which the acrylic resin (A) and the cellulose ester resin (B), which differ in their glass transition temperatures, are compatibilized lacks the glass transition temperatures unique to the respective resins and instead has one glass transition temperature.

The glass transition temperature of the film is determined as a mid-point glass transition temperature (Tmg) that is measured under conditions involving a temperature rise rate of 20° C./min using a differential scanning calorimeter (model DSC-7 manufactured by PerkinElmer, Inc.) according to JIS K7121 (1987).

The weight-average molecular weight Mw of the acrylic resin (A) contained in the polarizer protective film of the present invention and the weight-average molecular weight Mw or the degree of acyl substitution of the cellulose ester resin (B) contained therein can be each measured after separation of each resin using a solvent that selectively dissolves only the acrylic resin (A) or the cellulose ester resin (B). Each resin can be separated by immersion of the polarizer protective film in a solvent that dissolves only either of the acrylic resin (A) or the cellulose ester resin (B) and the subsequent extraction of the dissolved resin. In addition, heating or reflux may be performed. The step of separating each resin using such a solvent may be performed twice or more to fractionate the resins. The dissolved resin is separated from insoluble resin residues by filtration. The solvent can be evaporated from the filtrate to obtain the resin. The molecular weight distribution of the resin thus fractionated can be measured by gel permeation chromatography or high-performance liquid chromatography mentioned above.

There are cases that 1) the resins (A) and (B) compatibilized with each other may be separated from each other using a gel permeation chromatography (GPC) column, and 2) may not be separated from each other using a GPC column.

In the case of 1), a high-molecular-weight resin can be eluted at an early stage using the GPC column while a low-molecular-weight resin can be eluted after a lapse of a long time therefrom to thereby easily fractionate the resins (A) and (B) compatibilized with each other. Then, the respective molecular weights of the fractionated resins (A) and (B) can be measured.

In the case of 2), the molecular weight of the resins compatiblized with each other is measured by GPC. Then, an eluted resin solution is collected at each point in time. After distilling off of the solvent and drying, the resin is structurally analyzed to detect resin composition for each of fractions with different molecular weights. The respective amounts of the resins (A) and (B) can thereby be determined for each fraction.

Regarding Lactone Ring-Containing Polymer

The lactone ring-containing polymer has a lactone ring structure represented by general formula (1):

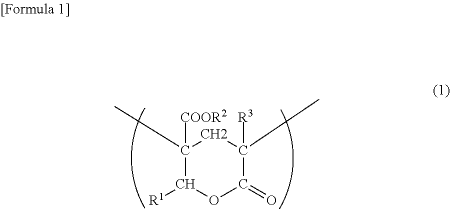

In general formula (1), R², and R³ each independently represent a hydrogen atom or a C₁₋₂₀ organic residue.

Examples of the organic residue represented by R¹ include C₁₋₁₈ alkyl groups, C₃₋₁₀ cycloalkyl groups, and aryl groups.

Examples of the organic residue represented by R² include C₁₋₁₈ alkyl groups, C₃₋₁₀ cycloalkyl groups, aryl groups, C₁₋₈ hydroxyalkyl groups, —(CH₂)ₘNR¹¹R¹², —(CH₂)ₘN(R¹¹R¹²R¹³)⁺.M⁻, and —(C₂H₄O)ₚR¹⁴ where R¹¹, R¹², and R¹³ may be the same or different and each represent a C₁₋₈ alkyl group; R¹⁴ represents a C₁₋₁₈ alkyl group; m represents 2 to 5; p represents 1 to 80; M⁻ represents Cl⁻, Br⁻, SO₄²⁻, PO₄³⁻, CH₃COO⁻, or HCOO⁻. R² is preferably a hydrogen atom or a C₁₋₁₈ alkyl group, more preferably a hydrogen atom, a methyl group, or an ethyl group.

Examples of the organic residue represented by R³ include C₁₋₁₈ alkyl groups, C₃. cycloalkyl groups, aryl groups, and C₁₋₈ hydroxyalkyl groups. R³ is preferably a hydrogen atom, a C₁₋₁₈ alkyl group, or a C₁₋₈ hydroxyalkyl group, more preferably a hydrogen atom, a methyl group, or a 2-hydroxyethyl group.

The content of the lactone ring structure represented by general formula (1) in the lactone ring-containing polymer is preferably 5 to 90 mass %, more preferably 10 to 70 mass %, even more preferably 10 to 60 mass %, particularly preferably 10 to 50 mass %, for example, from the viewpoint of adjusting photoelastic coefficient c. The lactone ring-containing polymer having a larger content of the lactone ring-containing structure can have a positively increased photoelastic coefficient c.

The lactone ring-containing polymer has a structure other than the lactone ring structure represented by general formula (1). The structure other than the lactone ring structure represented by general formula (1) is, but not limited to, preferably polymer building blocks (repeating structural units) constructed by polymerizing at least one monomer selected from (meth)acrylic acid esters, hydroxy group-containing monomers, unsaturated carboxylic acids, and monomers represented by the following general formula (2), more preferably polymer building blocks (repeating structural units) of (meth)acrylic acid ester:

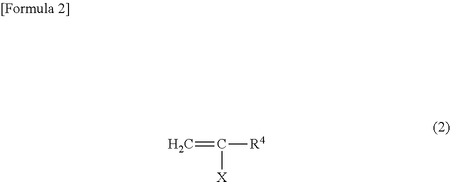

In formula (2), R⁴ represents a hydrogen atom or a methyl group; X represents a hydrogen atom, a C₁₋₂₀ alkyl group, an aryl group, a —OAc group, a —CN group, a —CO—R⁵ group, or a —C—O—R⁶ group; Ac group represents an acetyl group; and R⁵ and R⁶ each represent a hydrogen atom or a C₁₋₂₀ organic residue.

As to the content of the structure other than the lactone ring structure represented by general formula (1) in the lactone ring-containing polymer, in the case of polymer building blocks (repeating structural units) constructed by polymerizing a (meth)acrylic acid ester, the content is preferably 10 to 95 mass %, more preferably 10 to 90 mass %, even more preferably 40 to 90 mass %, particularly preferably 50 to 90 mass % of the lactone ring-containing polymer. In the case of polymer building blocks (repeating structural units) constructed by polymerizing a hydroxy group-containing monomer, the content is preferably 0 to 30 mass %, more preferably 0 to 20 mass %, even more preferably 0 to 15 mass %, particularly preferably 0 to 10 mass % of the lactone ring-containing polymer. In the case of polymer building blocks (repeating structural units) constructed by polymerizing a unsaturated carboxylic acid, the content is preferably 0 to 30 mass %, more preferably 0 to 20 mass %, even more preferably 0 to 15 mass %, particularly preferably 0 to 10 mass % of the lactone ring-containing polymer. In the case of polymer building blocks (repeating structural units) constructed by polymerizing a monomer represented by general formula (2), the content is preferably 0 to 30 mass %, more preferably 0 to 20 mass %, even more preferably 0 to 15 mass %, particularly preferably 0 to 10 mass % of the lactone ring-containing polymer.

The lactone ring-containing polymer can be produced by any method and is preferably obtained through a polymerization step of obtaining a polymer having a hydroxy group and an ester group in the molecular chain and a lactone cyclocondensation step of heating the obtained polymer to introduce a lactone ring structure to the polymer.

The polymerization step involves obtaining the polymer having a hydroxy group and an ester group in the molecular chain through the polymerization reaction of monomeric components including a monomer represented by the following general formula (3):

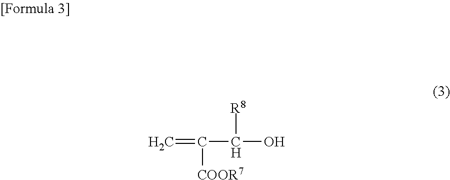

In general formula (3), R⁷ and R⁸ each independently represent a hydrogen atom or a C₁₋₂₀ organic residue. Examples of the monomer represented by general formula (3) include methyl 2-(hydroxymethyl)acrylate, ethyl 2-(hydroxymethyl)acrylate, isopropyl 2-(hydroxymethyl)acrylate, normal butyl 2-(hydroxymethyl)acrylate, and tertiary butyl 2-(hydroxymethyl)acrylate. Among them, methyl 2-(hydroxymethyl)acrylate or ethyl 2-(hydroxymethyl)acrylate is preferred. Methyl 2-(hydroxymethyl)acrylate is particularly preferred because the present invention can sufficiently exert its effects. These monomers represented by general formula (3) may be used alone or in combination.

The content of the monomer represented by general formula (3) in the monomeric components to be subjected to the polymerization step is preferably 5 to 90 mass %, more preferably 10 to 70 mass %, even more preferably 10 to 60 mass %, particularly preferably 10 to 50 mass %.

The monomeric components to be subjected to the polymerization step may include monomer(s) other than the monomer represented by general formula (3). Examples of such a monomer preferably include, as mentioned above, (meth)acrylic acid esters, hydroxy group-containing monomers, unsaturated carboxylic acids, and monomers represented by general formula (2). These monomers other than the monomer represented by general formula (2) may be used alone or in combination.

Examples of the (meth)acrylic acid esters include (meth)acrylic acid esters other than the monomer represented by general formula (3), for example, but not limited to: acrylic acid esters such as methyl acrylate, ethyl acrylate, n-butyl acrylate, isobutyl acrylate, t-butyl acrylate, cyclohexyl acrylate, and benzyl acrylate; and methacrylic acid esters such as methyl methacrylate, ethyl methacrylate, propyl methacrylate, n-butyl methacrylate, isobutyl methacrylate, t-butyl methacrylate, cyclohexyl methacrylate, and benzyl methacrylate. These (meth)acrylic acid esters may be used alone or in combination. Among them, methyl methacrylate is particularly preferred because the present invention can sufficiently exert its effects.

In the case of using the (meth)acrylic acid ester other than the monomer represented by general formula (2), its content in the monomeric components to be subjected to the polymerization step is preferably 10 to 95 mass %, more preferably 10 to 90 mass %, even more preferably 40 to 90 mass %, particularly preferably 50 to 90 mass %.

Examples of the hydroxy group-containing monomers include hydroxy group-containing monomers other than the monomer represented by general formula (3), for example, but not limited to, α-hydroxymethylstyrene, α-hydroxyethylstyrene, 2-(hydroxyalkyl)acrylic acid esters such as methyl 2-(hydroxyethyl)acrylate, and 2-(hydroxyalkyl)acrylic acids such as 2-(hydroxyethyl)acrylic acid. These monomers may be used alone or in combination.

In the case of using the hydroxy group-containing monomer other than the monomer represented by general formula (3), its content in the monomeric components to be subjected to the polymerization step is preferably 0 to 30 mass %, more preferably 0 to 20 mass %, even more preferably 0 to 15 mass %, particularly preferably 0 to 10 mass %.

Examples of the unsaturated carboxylic acids include acrylic acid, methacrylic acid, crotonic acid, α-substituted acrylic acid, and α-substituted methacrylic acid. These unsaturated carboxylic acids may be used alone or in combination. Among them, acrylic acid or methacrylic acid is particularly preferred.

In the case of using the unsaturated carboxylic acid, its content in the monomeric components to be subjected to the polymerization step is preferably 0 to 30 mass %, more preferably 0 to 20 mass %, even more preferably 0 to 15 mass %, particularly preferably 0 to 10 mass %.

Examples of the monomers represented by general formula (2) include styrene, vinyltoluene, α-methylstyrene, acrylonitrile, acryloylmorpholine, methyl vinyl ketone, ethylene, propylene, vinyl acetate, and N-vinylpyrrolidone. These monomers may be used alone or in combination. Among them, styrene or α-methylstyrene is particularly preferred.

In the case of using the monomer represented by general formula (2), its content in the monomeric components to be subjected to the polymerization step is preferably 0 to 30 mass %, more preferably 0 to 20 mass %, even more preferably 0 to 15 mass %, particularly preferably 0 to 10 mass %.

The polymerization for obtaining the polymer having a hydroxy group and an ester group in the molecular chain through the polymerization reaction of monomeric components is preferably polymerization using a solvent, particularly preferably through solution polymerization.

The polymerization step yields a polymer having a hydroxy group and an ester group in the molecular chain. This polymer has a weight-average molecular weight of preferably 1000 to 1000000, more preferably 5000 to 500000, particularly preferably 10000 to 200000. The polymer obtained in the polymerization step is heat-treated in the subsequent lactone cyclocondensation step to introduce a lactone ring structure to the polymer. In this way, the lactone ring-containing polymer is obtained.

The introduction of a lactone ring structure to the polymer obtained in the polymerization step is caused by the reaction through which the hydroxy group and the ester group in the molecular chain of the polymer are cyclocondensed by heating to form a lactone ring structure. This cyclocondensation yields an alcohol as a by-product.

The lactone ring-containing polymer has a 5% mass loss temperature of preferably 280° C. or higher, more preferably 290° C. or higher, even more preferably 300° C. or higher, in thermogravimetric analysis (TG). The 5% mass loss temperature in thermogravimetric analysis (TG) serves as a measure of thermal stability. A polymer having this temperature lower than 280° C. might not exhibit sufficient thermal stability.

The lactone ring-containing polymer has a glass transition temperature (Tg) of preferably 115° C. or higher, more preferably 125° C. or higher, even more preferably 130° C. or higher, further preferably 135° C. or higher, most preferably 140° C. or higher.

The polarizer protective film of the present invention may further contain other resins, if necessary, in addition to the lactone ring-containing polymer. Specifically, the polarizer protective film of the present invention may be constituted by a lactone ring-containing polymer composition containing the lactone ring-containing polymer and, if necessary, an additional resin.

Preferred examples of the additional resin contained in the lactone ring-containing polymer composition include AS resin (acrylonitrile-styrene copolymer), for example, for the purpose of adjusting photoelastic coefficient c or retardation R₀ or Rt. For example, the photoelastic coefficient c of the film can be adjusted by the copolymerization ratio between acrylonitrile and styrene constituting the AS resin.

The polarizer protective film of the present invention may further contain an additional resin and an additive, if necessary. Examples of the additional resin include acrylic particles (C).

Acrylic Particle (C)

Acrylic particle (C) is preferably an acrylic particle (C) having a layer structure having two or more layers, more preferably an acrylic granular composite having a multilayer structure described below.

The acrylic granular composite having a multilayer structure is an acrylic granular composite in which a “layer consisting of an innermost hard layer polymer”, a “layer consisting of a cross-linked soft layer polymer”, and a “layer consisting of an outermost hard layer polymer” are stacked in the order named from the center toward the outer side.

Preferred examples of the acrylic granular composite having a multilayer structure include an acrylic granular composite that has a three-layer core-shell structure having (a) a layer consisting of an innermost hard layer polymer, (b) a layer consisting of a cross-linked soft polymer, and (c) a layer consisting of an outermost hard polymer described below at contents of 5 to 40 mass % of the innermost hard layer polymer (a), 30 to 60 mass % of the cross-linked soft layer polymer (b), and 20 to 50 mass % of the outermost hard layer polymer (c), and has an insoluble portion with a degree of swelling of 1.5 to 4.0 in methyl ethyl ketone, the insoluble portion being obtained by fractionation with acetone.

Preferably, the tensile modulus of elasticity of the acrylic granular composite having a multilayer structure and the degree of swelling in methyl ethyl ketone of the insoluble portion obtained by fractionation with acetone are set to ranges disclosed in Japanese Patent Publication No. 60-17406 or 03-39095. This is because the sufficient balance between impact resistance and stress whitening resistance can thereby be realized.

The innermost hard layer polymer (a) is obtained by the polymerization of a monomeric mixture consisting of 80 to 98.9 mass % of methyl methacrylate, 1 to 20 mass % of alkyl acrylate having a C₁₋₈ alkyl group, and 0.01 to 0.3 mass % of a polyfunctional grafting agent.

Examples of the alkyl acrylate having a C₁₋₈ alkyl group, contained in the innermost hard layer polymer (a) include methyl acrylate, ethyl acrylate, n-propyl acrylate, n-butyl acrylate, s-butyl acrylate, and 2-ethylhexyl acrylate. Methyl acrylate or n-butyl acrylate is preferred.

Preferably, the innermost hard layer polymer (a) contains 1 to 20 mass % of the alkyl acrylate unit. A polymer containing less than 1 mass % of the alkyl acrylate unit is more susceptible to thermal decomposition. By contrast, an innermost hard layer polymer (α) containing more than 20 mass % of the alkyl acrylate unit has a low glass transition temperature and is less effective for imparting impact resistance to the acrylic granular composite having a three-layer structure. Thus, either case is not preferred.

Examples of the polyfunctional grafting agent contained in the innermost hard layer polymer (a) include polyfunctional monomers having polymerizable functional groups, other than alkyl acrylate or methyl methacrylate, for example, allyl esters of acrylic acid, methacrylic acid, maleic acid, and fumaric acid. Allyl methacrylate is preferably used. The polyfunctional grafting agent is used in order to chemically bond the innermost hard layer polymer (a) to the cross-linked soft layer polymer (b) and used at a proportion of 0.01 to 0.3 mass % in the polymerization for the innermost hard layer polymer (a).

The cross-linked soft layer polymer (b) is obtained by the polymerization of a monomeric mixture consisting of 75 to 98.5 mass % of alkyl acrylate having a C₄₋₈ alkyl group, 0.01 to 5 mass % of a polyfunctional cross-linking agent, and 0.5 to 5 mass % of a polyfunctional grafting agent in the presence of the innermost hard layer polymer (a).

Examples of the alkyl acrylate having a C₄₋₈ alkyl group, contained in the cross-linked soft layer polymer (b) include n-butyl acrylate and 2-ethylhexyl acrylate. This alkyl acrylate having a C₄₋₈ alkyl group may be copolymerized with 25 mass % or less of an additional copolymerizable monomer. Examples of the copolymerizable monomer include styrene and substituted styrene derivatives. As for the ratio between the alkyl acrylate having a C₄₋₈ alkyl group and the styrene, a larger proportion of the former can lower the glass transition temperature of the polymer (b), i.e., can soften the polymer (b).

From the viewpoint of the transparency of the resin composition, it is advantageous to allow the cross-linked soft layer polymer (b) to have a refractive index, at ordinary temperature, close to those of the innermost hard layer polymer (a), the outermost hard layer polymer (c), and a hard thermoplastic acrylic resin. The ratio between the alkyl acrylate having a C₄₋₈ alkyl group and the styrene is selected in consideration of these conditions.

The polyfunctional cross-linking agent contained in the cross-linked soft layer polymer (b) can be a generally known cross-linking agent such as a divinyl compound, a diallyl compound, a diacrylic compound, or a dimethacrylic compound. Polyethylene glycol diacrylate (molecular weight: 200 to 600) is preferably used. The polyfunctional cross-linking agent is used in order to form a cross-linked structure during the polymerization for the soft layer (b) so that the cross-linked soft layer polymer (b) can exert its effect of imparting impact resistance. The aforementioned polyfunctional grafting agent, when used in the polymerization for the soft layer (b), can form the cross-linked structure of the soft layer (b) to some extent. Thus, the polyfunctional cross-linking agent is not an essential component. The polyfunctional cross-linking agent is used at a proportion of preferably 0.01 to 5 mass % in the polymerization for the soft layer from the viewpoint of the effect of imparting impact resistance.

The polyfunctional grafting agent contained in the cross-linked soft layer polymer (b) may be the same as that contained in the innermost hard layer polymer (a). The polyfunctional grafting agent contained in the cross-linked soft layer polymer (b) is used in order to chemically bond the cross-linked soft layer polymer (b) to the outermost hard layer polymer (c) and used at a proportion of preferably 0.5 to 5 mass % in the polymerization for the cross-linked soft layer polymer (b) from the viewpoint of the effect of imparting impact resistance.

The outermost hard layer polymer (c) is obtained by the polymerization of a monomeric mixture consisting of 80 to 99 mass % of methyl methacrylate and 1 to 20 mass % of alkyl acrylate having a C₁₋₈ alkyl group in the presence of the innermost hard layer polymer (a) and the cross-linked soft layer polymer (b).

The alkyl acrylate contained in the outermost hard layer polymer (c) may be the same as that in the innermost hard layer polymer (a) and is preferably methyl acrylate or ethyl acrylate. Preferably, the outermost hard layer (c) contains 1 to 20 mass % of the alkyl acrylate unit.

A chain transfer agent such as alkylmercaptan may be used for obtaining the outermost hard layer polymer (c). This chain transfer agent can adjust the molecular weight of the polymer and may enhance compatibility with the acrylic resin (A).

For enhancing the balance between the elongation and impact resistance of the acrylic particle (C), it is particularly preferred to provide a gradient such that the molecular weight of the outermost hard layer polymer (c) is gradually decreased from the inner side toward the outer side of the outermost hard layer. For this purpose, for example, the monomeric mixture for forming the outermost hard layer is divided into two or more parts, and he amount of the chain transfer agent to be added to each part of the divided monomeric mixture is sequentially increased among the parts. The molecular weight of the resulting outermost hard layer can be predicted by: polymerizing the monomeric mixture under the same conditions as in the formation of the outermost hard layer; and measuring the molecular weight of the resulting polymer.

The mass ratio between the core and the shell in the acrylic granular composite having a multilayer structure is, but not limited to, preferably 50 parts by mass or higher and 90 parts by mass or lower, more preferably 60 parts by mass or higher and 80 parts by mass or lower of the core layer with respect to 100 parts by mass in total of the acrylic granular composite having a multilayer structure. The core layer means the innermost hard layer.

Examples of commercially available products of the acrylic granular composite having a multilayer structure include “Metablen” manufactured by Mitsubishi Rayon Co., Ltd., “Kane Ace” manufactured by Kaneka Corp., “Paraloid” manufactured by Kureha Corp., “Acryloid” manufactured by Rohm and Haas Company, “Stafiloid” manufactured by Ganz Chemical Co., Ltd., and “Parapet SA” manufactured by Kuraray Co., Ltd. These acrylic granular composites can be used alone or in combination.

The acrylic particle (C) may be a graft copolymer. Examples of such a graft copolymer include a graft copolymer obtained by the copolymerization of a monomeric mixture consisting of an unsaturated carboxylic acid ester monomer, an unsaturated carboxylic acid monomer, an aromatic vinyl monomer, and, if necessary, an additional vinyl monomer copolymerizable therewith in the presence of a rubbery polymer.

The rubbery polymer that can be used for obtaining the graft copolymer can be, but not limited to, for example, diene-based rubber, acrylic rubber, or ethylene-based rubber. Specific examples thereof include polybutadiene, styrene-butadiene copolymers, styrene-butadiene block copolymers, acrylonitrile-butadiene copolymers, butyl acrylate-butadiene copolymers, polyisoprene, butadiene-methyl methacrylate copolymers, butyl acrylate-methyl methacrylate copolymers, butadiene-ethyl acrylate copolymers, ethylene-propylene copolymers, ethylene-propylene-diene copolymers, ethylene-isoprene copolymers, and ethylene-methyl acrylate copolymers. These rubbery polymers may be used alone or as a mixture of two or more types.

Examples of commercially available products of the acrylic particle (C) in the form of a graft copolymer include Metablen W-341 (C2) (manufactured by Mitsubishi Rayon Co., Ltd.) and Chemisnow MR-2G (C3) and MS-300X (C4) (manufactured by Soken Chemical & Engineering Co., Ltd.).

The acrylic particle (C) has a particle size of, but not limited to, preferably 10 nm or larger and 1000 nm or smaller, more preferably 20 nm or larger and 500 nm or smaller, particularly preferably 50 nm or larger and 400 nm or smaller.

For obtaining a highly transparent film, it is preferred that the refractive index of the mixture of the acrylic resin (A) and the cellulose ester resin (B) be close to that of the acrylic particle (C). Specifically, the acrylic particle (C) and the acrylic resin (A) differ in refractive index preferably by 0.05 or less, more preferably by 0.02 or less, particularly preferably by 0.01 or less.

Such a relationship of the refractive indexes can be satisfied by decreasing the difference in refractive index by, for example, a method which involves adjusting the compositional ratio of each monomer unit in the acrylic resin (A) or a method which involves adjusting the compositional ratio of the rubbery polymer or the monomer for use in the acrylic particle (C). The resulting polarizer protective film can be excellent in transparency.

The difference in refractive index refers to a difference in refractive index (23° C., measurement wavelength: 550 nm) measured by: fully dissolving, under appropriate conditions, the polarizer protective film of the present invention in a solvent capable of dissolving the acrylic resin (A); separating the resulting cloudy solution into a solvent-dissolved portion and an insoluble portion by operation such as centrifugation; and purifying each of the dissolved portion (acrylic resin (A)) and the insoluble portion (acrylic particle (C)), followed by refractive index measurement.

Preferably, the acrylic resin (A) is mixed with the acrylic particles (C) by, but not limited to, a method which involves blending in advance the acrylic resin (A) with other arbitrary components and then uniformly melt-kneading the blend usually at 200° C. to 350° C. using a single-screw or twin-screw extruder while adding the acrylic particles (C) thereto.

Alternatively, the acrylic resin (A) may be mixed with the acrylic particles (C) by, for example, a method which involves adding a preliminary dispersion of the acrylic particles (C) to a solution containing the acrylic resin (A) and the cellulose ester resin (B) dissolved therein (dope solution) and mixing these solutions, or a method which involves dissolving or mixing the acrylic particles (C) and other arbitrary additives and adding the resulting solution in an in-line manner to such a dope solution.

The polarizer protective film contains preferably 0.5 to 30 mass %, more preferably 1.0 to 15 mass % of the acrylic particles (C).

Other Additives

The polarizer protective film of the present invention may further contain, if necessary, a plasticizer in order to improve the flowability or flexibility of the resin composition during film formation. Examples of the plasticizer include phthalic acid ester-based plasticizers, fatty acid ester-based plasticizers, trimellitic acid ester-based plasticizers, phosphoric acid ester-based plasticizers, polyester-based plasticizers, and epoxy-based plasticizers. Among them, a polyester-based plasticizer or a phthalic acid ester-based plasticizer is preferred. The polyester-based plasticizer is less likely to bleed out, but slightly inferior in plasticizing effect or compatibility, compared with the phthalic acid ester-based plasticizer such as dioctyl phthalate.

The polyester-based plasticizer is a polyester compound that is obtained through the reaction between a monovalent to tetravalent carboxylic acid and a monohydric to hexahydric alcohol and is preferably a polyester compound that is obtained through the reaction between a divalent carboxylic acid and a glycol.

Typical examples of the divalent carboxylic acid include glutaric acid, itaconic acid, adipic acid, phthalic acid, azelaic acid, and sebacic acid. Particularly, a polyester compound constituted by a component such as adipic acid or phthalic acid is excellent in plasticizing effect. Examples of the glycol include glycols of ethylene, propylene, 1,3-butylene, 1,4-butylene, 1,6-hexamethylene, neopentylene, diethylene, triethylene, and dipropylene. These divalent carboxylic acids or glycols may be used alone or as a mixture.

The polyester-based plasticizer has a molecular weight in the range of preferably 100 to 10000, more preferably in the range of 600 to 3000 because of large plasticizing effect.

The viscosity of the plasticizer correlates with its molecular structure or molecular weight. Preferably, the adipic acid-based plasticizer has a viscosity in the range of 200 to 5000 MPa·s (25° C.) in teens of compatibility or plasticization efficiency. Some polyester-based plasticizers may be used in combination.

Preferably, the content of the plasticizer is set to 0.5 to 30 parts by mass with respect to 100 parts by mass of the polarizer protective film of the present invention. A plasticizer contained at a content exceeding 30 parts by mass is practically unfavorable because the plasticizer bleeds out to make the film surface sticky.

The polarizer protective film of the present invention may further contain a UV absorber, if necessary. Examples of the UV absorber include benzotriazole-based, 2-hydroxybenzophenone-based, and salicylic acid phenyl ester-based UV absorbers.

Specific examples thereof include: triazoles such as 2-(5-methyl-2-hydroxyphenyl)benzotriazole, 2-[2-hydroxy-3,5-bis(α,α-dimethylbenzyl)phenyl]-2H-benzotriazole, and 2-(3,5-di-t-butyl-2-hydroxyphenyl)benzotriazole; and benzophenones such as 2-hydroxy-4-methoxybenzophenone, 2-hydroxy-4-octoxybenzophenone, and 2,2′-dihydroxy-4-methoxybenzophenone.

A UV absorber having a molecular weight of 400 or larger does not easily volatilize because of its high boiling point and therefore rarely flies out even during high-temperature molding. Thus, such a UV absorber can effectively impart weather resistance to the film even when added in a small amount.

Examples of the UV absorber having a molecular weight of 400 or larger include: benzotriazole-based UV absorbers such as 2-[2-hydroxy-3,5-bis(α,α-dimethylbenzyl)phenyl]-2-benzotriazole and 2,2-methylenebis[4-(1,1,3,3-tetrabutyl)-6-(2H-benzotriazol-2-yl)phenol]; hindered amine-based UV absorbers such as bis(2,2,6,6-tetramethyl-4-piperidyl) sebacate and bis(1,2,2,6,6-pentamethyl-4-piperidyl) sebacate; and hybrid-based UV absorbers having both hindered phenol and hindered amine structures in their molecules, such as bis(1,2,2,6,6-pentamethyl-4-piperidyl) 2-(3,5-di-t-butyl-4-hydroxybenzyl)-2-n-butylmalonate and 1-[2-[3-(3,5-di-t-butyl-4-hydroxyphenyl)propionyloxy]ethyl]-4-[3-(3,5-di-t-butyl-4-hydroxyphenyl)propionyloxy]-2,2,6,6-tetramethylpiperidine. These UV absorbers can be used alone or in combination. Of the foregoing, 2-[2-hydroxy-3,5-bis(α,α-dimethylbenzyl)phenyl]-2-benzotriazole or 2,2-methylenebis[4-(1,1,3,3-tetrabutyl)-6-(2H-benzotriazol-2-yl)phenol] is particularly preferred.

The polarizer protective film of the present invention may further contain an antioxidant, for example, in order to reduce thermal decomposition or thermal coloration during the molding process. Also, the polarizer protective film of the present invention may further contain an antistatic agent in order to impart antistatic performance thereto. The polarizer protective film of the present invention may further contain a phosphorus-based flame retardant in order to impart flame resistance thereto.

Examples of the phosphorus-based flame retardant include red phosphorus, triaryl phosphate, diaryl phosphate, monoaryl phosphate, aryl phosphonic acid compounds, arylphosphine oxide compounds, condensed aryl phosphate, halogenated alkyl phosphate, halogen-containing condensed phosphoric acid ester, halogen-containing condensed phosphonic acid ester, and halogen-containing phosphorous acid ester. These phosphorus-based flame retardants may be used alone or as a mixture of two or more types. Specific examples of the phosphorus-based flame retardant include triphenyl phosphate, 9,10-dihydro-9-oxa-10-phosphaphenanthrene-10-oxide, phenyl phosphonic acid, tris(β-chloroethyl)phosphate, tris(dichloropropyl)phosphate, and tris(tribromoneopentyl)phosphate.

Method for producing polarizer protective films 46 (F2) and 64 (F3) An example of the method for producing polarizer protective films 46 (F2) and 64 (F3) will be described. However, the present invention is not limited to this example.

Production methods such as inflation, T-die, calendaring, cutting, casting, emulsion, and hot press methods can be used for producing each polarizer protective film of the present invention. A casting method is preferred from the viewpoint of, for example, suppressing coloration, reducing foreign matter-related defects, and reducing optical defects such as die lines. Particularly, a solution casting method is more preferred.

The production of the polarizer protective film by the solution casting method involves the steps of 1) preparing a dope, 2) casting the dope onto an endless metal support, 3) drying the casted dope to prepare a web (solvent evaporation step), 4) peeling the web from the metal support, 5) drying the web, followed by stretching to obtain a stretched film, and 6) rolling up the stretched film (polarizer protective film).

1) Step of Preparing Dope

This step involves dissolving the acrylic resin (A), the cellulose ester resin (B), and optionally, the acrylic particles (C) and other additives with stirring in an dissolution vessel containing an organic solvent composed mainly of a good solvent for the acrylic resin (A) and the cellulose ester resin (B) to form a dope, or involves mixing the solution of the acrylic resin (A) and the cellulose ester resin (B), optionally with a solution of the acrylic particles (C) and solutions of other additives to form a dope which is a main solution.

The acrylic resin (A) and the cellulose ester resin (B) can be dissolved using various dissolution methods such as a method which involves dissolving these resins at ordinary pressure, a method which involves dissolving the resins at a temperature equal to or lower than the boiling point of the main solvent, a method which involves dissolving the resins by pressurization at a temperature equal to or higher than the boiling point of the main solvent, a method which involves dissolving the resins by cooling as described in Japanese Patent Application Laid-Open No. 9-95544, 9-95557, or 9-95538, and a method which involves dissolving the resins at a high pressure as described in Japanese Patent Application Laid-Open No. 11-21379. Particularly, the method which involves dissolving the resins by pressurization at a temperature equal to or higher than the boiling point of the main solvent is preferred.

The organic solvent useful in forming the dope can be any solvent that simultaneously dissolves the acrylic resin (A), the cellulose ester resin (B), and optionally, other additives, without limitations.

Examples of chlorine-based organic solvents include methylene chloride. Examples of non-chlorine-based organic solvents include methyl acetate, ethyl acetate, amyl acetate, acetone, tetrahydrofuran, 1,3-dioxolane, 1,4-dioxane, cyclohexanone, ethyl formate, 2,2,2-trifluoroethanol, 2,2,3,3-hexafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol, and nitroethane. Methylene chloride, methyl acetate, ethyl acetate, or acetone can be preferably used.

Preferably, the dope contains 1 to 40 mass % of a C₁₋₄ linear or branched aliphatic alcohol, in addition to the above organic solvent. The dope having a higher proportion of alcohol yields a gelled web, which is easily peeled from the metal support. Alternatively, the alcohol added at a lower proportion also plays a role in promoting the dissolution of the acrylic resin (A) and the cellulose ester resin (B) in a non-chlorine-based organic solvent system.

The dope is particularly preferably a dope composition containing at least 15 to 45 mass % in total of three components, i.e., the acrylic resin (A), the cellulose ester resin (B), and the acrylic particles (C), dissolved in a solvent containing methylene chloride and a C₁₋₄ linear or branched aliphatic alcohol.

Examples of the C₁₋₄ linear or branched aliphatic alcohol include methanol, ethanol, n-propanol, isopropanol, n-butanol, sec-butanol, and tert-butanol. Of them, ethanol is preferred, for example, because the resulting dope has favorable stability and a relatively low boiling point and is well dryable.

Preferably, the dope contains 15 to 45 mass % in total of the acrylic resin (A) and the cellulose ester resin (B). Additives are added to the dope during or after dissolution to dissolve or disperse the components. Then, the mixture is filtered through a filtering medium, defoamed, and sent to the next step through a liquid feed pump

Preferably, this filtration employs a filtering medium that captures particles with a size of 0.5 to 5 μm with a filtering time of 10 to 25 sec/100 ml.

This method can remove only aggregates remaining during particle dispersion or aggregates occurring during addition of a main dope by use of the filtering medium that captures particles with a size of 0.5 to 5 μm with a filtering time of 10 to 25 sec/100 ml. The main dope has a much lower particle concentration than that of a loading solution and is therefore free from a rapid rise in filtration pressure attributed to the attachment of the aggregates during the filtration.

If necessary, large aggregates are removed using a filter from a vessel charged with the acrylic particles. The resulting solution is sent to a stock vessel. Then, the loading solution of the acrylic particles are added from the stock vessel to a main dope dissolution vessel. Then, the main dope solution is filtered through a main filter. A UV absorber loading solution is added thereto in an in-line manner.

In many cases, the main dope may contain approximately 10 to 50 mass % of a return material. The return material may contain acrylic particles. In such a case, it is preferred to control the amount of the loading solution of the acrylic particles added according to the amount of the return material added.

The loading solution of the acrylic particles contains preferably 0.5 to 10 mass %, more preferably 1 to 10 mass %, most preferably 1 to 5 mass % of the acrylic particles. The loading solution containing the acrylic particles within the range described above is preferred because this loading solution is easily handleable because of its low viscosity and can be easily added to the main dope.

The return material refers to a finely crushed polarizer protective film; a film from which both sides have been cut off during the formation of the polarizer protective film or a raw polarizer protective film that has fallen outside of specifications due to scratches can be used as the return material.

Alternatively, the acrylic resin, the cellulose ester resin, and optionally, the acrylic particles may be kneaded in advance for pelleting, and this pellet can be preferably used as the return material.

2) Casting Step

This step involves sending the dope through a liquid feed pump (e.g., a pressurization-type metering gear pump) to a pressure die and casting the dope from the pressure die slit to a casting position on a metal support such as an endless metal belt capable of infinite transport, for example, a stainless belt, or a rotary metal drum.

A preferred pressure die has an adjustable slit shape of the mouthpiece and can easily offer a uniform film thickness. Any of coat hanger dies, T-dies, and the like can be preferably used as the pressure die. The metal support has a specular surface. In order to increase a film forming rate, two or more pressure dies may be provided on the metal support. In such a case, the dope is dispensed to the dies to form a layered film. Alternatively, a film having a layered structure may be preferably obtained by a co-casting method which involves simultaneously casting a plurality of dopes.

3) Solvent Evaporation Step

This step involves heating the web (a dope film formed by casting the dope onto the support for casting is called a web) on the support for casting to evaporate the solvent.

The solvent can be evaporated by, for example, a method which involves blowing air to the web and/or a method which involves transferring heat to the web from the back surface of the support using a liquid or a method which involves transferring heat to the web from its front and back surfaces using radiation heat. The method which involves transferring heat to the web from the back surface of the support using a liquid is preferred because of its high drying efficiency. These methods are also preferably used in combination. Preferably, the web on the support after casting is dried on the support in an atmosphere of 40° C. to 100° C. For keeping the web in an atmosphere of 40° C. to 100° C., it is preferred to expose the upper surface of the web to hot air of this temperature or heat the web by infrared rays or other means.

Preferably, the web is peeled from the support within 30 to 120 seconds from the viewpoint of surface quality, moisture permeability, and peel properties.

4) Peeling Step

This step involves peeling the web at a peeling position on the metal support after solvent evaporation. The peeled web is sent to the next step.

The temperature at the peeling position on the metal support is preferably 10° C. to 40° C., more preferably 11° C. to 30° C.

Preferably, the web on the metal support, when peeled therefrom, has 50 to 120 mass % residual solvents, depending on strong or weak drying conditions, the length of the metal support, etc. A web having a larger amount of residual solvents may be too soft when peeled. Such a web tends to lose flatness during peeling and is thus prone to wrinkles or lines extending lengthwise, due to peeling tension. Thus, the amount of residual solvents in the web during peeling is determined depending on the balance between production efficiency and quality.

The amount of residual solvents in the web is defined by the following equation:

Amount (%) of residual solvents=(Mass of the web before heat treatment−Mass of the web after heat treatment)/(Mass of the web after heat treatment)×100

The heat treatment for measuring the amount of residual solvents refers to heat treatment at 115° C. for 1 hour.

The film is peeled from the metal support at a peeling tension of usually 196 to 245 N/m. A film that is apt to be wrinkled during peeling is preferably peeled at a tension of 190 N/m or lower or preferably peeled at the minimum possible tension to 166.6 N/m and subsequently at the minimum possible tension to 137.2 N/m. Particularly preferably, the film is peeled at the minimum possible tension to 100 N/m.

In the present invention, the temperature at the peeling position on the metal support is set to preferably −50° C. to 40° C., more preferably 10° C. to 40° C., most preferably 15 to 30° C.

5) Drying and Stretching Step

The web thus peeled is dried using a drying apparatus where the web is conveyed by passing the web between a series of rolls disposed therein by turns or using a tenter stretching apparatus where the web is conveyed with its both ends clipped.

Common drying means involves blowing hot air to both surfaces of the web. Alternative means involves heating the web by exposure to microwave instead of air. Too rapid drying tends to impair the flatness of the resulting film. Preferably, drying at a high temperature is started when the amount of residual solvents reaches 8 mass % or lower. The web is generally dried at 40° C. to 250° C. as a whole. Particularly preferably, the web is dried at 40° C. to 160° C.

In the case of using the tenter stretching apparatus, an apparatus is preferably used that can control the right-side and left-side clamping lengths (distance from the start of clamping to the finish of clamping) of the film each individually by the clamping means on both sides of the tenter. In the tentering step, zones intentionally having different temperatures are also preferably created in order to improve flatness.

Also preferably, a neutral zone is provided between the zones having different temperatures in order to prevent these zones from interfering with each other.

The stretching operation may be performed in divided stages and is also preferably performed both in the casting direction and in the width direction (biaxial stretching). The biaxial stretching may be performed at once or in stages.

The phrase “in stages” may mean that, for example, stretching is performed in different directions sequentially and may mean that stretching in the same direction is divided into two or more stages while stretching in a direction different therefrom is added to any of the stages. Specifically, the stretching step may be performed, for example, as follows:

Stretching in the casting direction→Stretching in the width direction→Stretching in the casting direction→Stretching in the casting direction

Stretching in the width direction→Stretching in the width direction→Stretching in the casting direction→Stretching in the casting direction

The simultaneous biaxial stretching also includes the case where the film is stretched in one direction and contracted in the other direction with tension relaxed. Preferably, the simultaneous biaxial stretching is performed at a stretch ratio in the range of ×1.01 to ×1.5 both in the width direction (transverse direction: TD) and in the casting direction (machine direction: MD).

Preferably, the film stretching conditions are adjusted so that the film has a birefringence (nx−ny) under stress of 0 under any tensile stress applied thereto in the range of 5 MPa to 35 MPa. For this purpose, the film stretching conditions are preferably set according to the mixing ratio between the acrylic resin (A) having a negative photoelastic coefficient c and the cellulose ester resin (B) having a positive photoelastic coefficient c. In the case of, for example, 90/10 mixing ratio (A)/(B) between the acrylic resin (A) and the cellulose ester resin (B) having a positive photoelastic coefficient c, the film stretch ratio is preferably set to ×1.01 to ×1.50 for the film casting direction (MD direction).

Preferably, the web to be tentered has 20 to 100 mass % residual solvents at the start of tentering and is dried under tentering until the amount of residual solvents reaches 10 mass % or lower, more preferably 5 mass % or lower.

The drying temperature in the tentering is preferably 30° C. to 160° C., more preferably 50° C. to 150° C., most preferably 70° C. to 140° C.

In the tentering step, a low ambient temperature distribution in the width direction is preferred from the viewpoint of enhancing the homogeneity of the film. The temperature distribution in the width direction in the tentering step is preferably within ±5° C., more preferably within ±2° C., most preferably within ±1° C.

6) Rolling Up Step

This step involves, after the amount of residual solvents reaches 2 mass % or lower, rolling up the web as a polarizer protective film using a roll up device. A film wound when having 0.4 mass % or less residual solvents can have favorable dimensional stability. Particularly preferably, a film having 0.00 to 0.10 mass % residual solvents is wound.

A roll-up method generally used may be used in the present invention. For example, constant torque, constant tension, taper tension, and program tension control (internal stress is kept constant) methods can be selected according to use.

The polarizer protective film of the present invention is preferably a long film, which specifically refers to a film of approximately 100 m to 5000 m usually provided in a roll form. The film has a width of preferably 1.3 to 4 m, more preferably 1.4 to 2 m.

The polarizer protective film of the present invention has a thickness of, but not limited to, preferably 20 to 200 μm, more preferably 25 to 100 μm, particularly preferably 30 to 80 μm.

Regarding Polarizer Protective Films F1 and F4

Polarizer protective films 44 (F1) and 66 (F4) can each be any transparent resin film without limitations and are preferably thermoplastic resins. Preferred examples of such thermoplastic resins include cellulose ester films. Polarizer protective films 44 (F1) and 66 (F4) may further have other optical functions such as antireflective layers.

The cellulose ester films may be the cellulose ester films mentioned above or may be commercially available cellulose ester films without limitations. Examples of the commercially available products include cellulose ester films (e.g., Konica Minolta TAC KC8UX, KC4UX, KC5UX, KC8UY, KC4UY, KC12UR, KC8UCR-3, KC8UCR-4, KC8UCR-5, KC8UE, KC4UE, KC4FR-3, KC4FR-4, KC4HR-1, KC8UY-HA, and KC8UX-RHA, all manufactured by Konica Minolta Opto, Inc.).

Polarizer protective films 44 (F1) and 66 (F4) each have a thickness of, but not limited to, approximately 10 to 200 μm, preferably 10 to 100 μm, more preferably 10 to 70 μm.

Each polarizing plate can be produced by bonding the polarizer with the corresponding polarizer protective films (F1 to F4) mentioned above. For example, first polarizing plate 40 can be produced through the step of bonding polarizer protective film F1 to one surface of first polarizer 42 via an adhesive and bonding polarizer protective film F2 to the other surface of first polarizer 42 via an adhesive.

The adhesive for use in bonding has a storage elastic modulus in the range of preferably 1.0×10⁴ Pa to 1.0×10⁹ Pa at 25° C. in the form of an adhesive layer. Particularly, a curable adhesive that forms a high-molecular-weight product or a cross-linked product through various chemical reactions after application of the adhesive and bonding is preferably used.

Specific examples of the adhesive include: curable adhesives such as urethane-based adhesives, epoxy-based adhesives, water-based polymer isocyanate-based adhesives, and thermosetting acrylic adhesives; anaerobic adhesives such as moisture-curable urethane adhesives, polyether methacrylate types, ester-based methacrylate types, and oxidation-type polyether methacrylate; cyano acrylate-based instant adhesives; and acrylate/peroxide-based two-component instant adhesives. These adhesives may be of one-component type or may be of type in which two or more component are mixed for use.

Among them, a photocurable adhesive is preferred.

The above adhesive may be a solvent-based adhesive having an organic solvent as a medium, may be a water-based adhesive such as an emulsion-, colloidal dispersion-, or aqueous solution-type adhesive, which contains a medium composed mainly of water, or may be a solvent-free adhesive. The concentration of the adhesive in a solution can be appropriately determined according to the film thickness of the resulting adhesive layer, a coating method, coating conditions, etc. and is usually 0.1 to 50 mass %.

Hereinafter, the method for preparing each polarizing plate using the photocurable adhesive will be described.

The polarizing plate can be produced by a method which involves: an adhesive coating step of coating at least one of the surfaces of the polarizer and each polarizer protective film to be bonded, with the photocurable adhesive described below; a bonding step of bonding the polarizer with the polarizer protective film via the obtained coating layer of the photocurable adhesive; and a curing step of curing the coating layer of the photocurable adhesive.

Adhesive Application Step

The adhesive application step involves coating at least one of the surfaces of the polarizer and each protective film to be bonded, with the photocurable adhesive. The surface of the polarizer or the protective film may be coated directly with the photocurable adhesive by any coating method without limitations. For example, various coating systems such as doctor blades, wire bars, die coaters, comma coaters, and gravure coaters can be used. An alternative method that may be used involves casting the photocurable adhesive to between the polarizer and the protective film and then uniformly spreading the adhesive by pressurization using rolls or the like.

Bonding Step

The bonding step involves laminating the polarizer protective film to the photocurable adhesive applied to the surface of, for example, the polarizer in the preceding adhesive coating step. Alternatively, the bonding step involves laminating the polarizer to the photocurable adhesive applied to the surface of the polarizer protective film. Alternatively, this step involves laminating the polarizer and the polarizer protective film with the photocurable adhesive casted to between the polarizer and the protective film. The polarizer may be bonded at both surfaces with polarizer protective films using the photocurable adhesive for both surfaces. In such a case, both surfaces of the polarizer are laminated with the polarizer protective films via the photocurable adhesive. In this state, the resulting laminate is usually sandwiched between rolls or the like and pressurized from both surfaces (from the polarizer side and the protective film side in the case of the polarizer laminated at one surface with the protective film or from both protective film sides in the case of the polarizer laminated at both surfaces with the protective films) The rolls may be made of a material such as metal or rubber. The rolls to be disposed on both surfaces may be made of the same materials or different materials.

Curing Step

The curing step involves curing the coating layer of the photocurable adhesive disposed between the polarizer and each polarizer protective film by irradiation with actinic radiation. Specifically, a cationically polymerizable compound such as an epoxy compound or an oxetane compound contained in the coating layer of the photocurable adhesive is cured to form an adhesive layer containing a cured product of the cationically polymerizable compound between the polarizer and the polarizer protective film. The polarizer and the polarizer protective film are thereby bonded together.

In the case of the polarizer bonded at one surface with the protective film, the coating layer of the photocurable adhesive may be irradiated with actinic radiation either from the polarizer side or from the protective film side. In the case of the polarizer bonded at both surfaces with the polarizer protective films, the polarizer bonded at both surfaces with the polarizer protective films via the photocurable adhesive is advantageously irradiated, in this state, with actinic radiation from either polarizer protective film side to simultaneously cure the photocurable adhesive on both surfaces. Either protective film, however, may contain a UV absorber (e.g., in the case of using a cellulose-based resin film containing a UV absorber as either protective film), and the actinic radiation may be UV rays. In such a case, the irradiation is usually performed with the UV rays from the UV absorber-free protective film side.

The actinic radiation can be visible rays, UV rays, X-rays, electron beams, or the like. UV rays are generally preferred because of easy handling and a sufficient curing rate. A light source used for the actinic radiation can be, but not limited to, a light source having an emission distribution at a wavelength of 400 nm or lower, for example, a low-pressure mercury lamp, a medium-pressure mercury lamp, a high-pressure mercury lamp, an ultrahigh-pressure mercury lamp, a chemical lamp, a black-light lamp, a microwave-powered mercury lamp, a metal halide lamp, or a LED lamp.

The light irradiation intensity for the photocurable adhesive is not particularly limited and set according to the composition of the photocurable adhesive, and preferably set so that irradiation intensity in a wavelength region effective for the activation of the polymerization initiator is 1 to 3,000 mW/cm² in terms of UV-B (mid-wavelength UV rays of 280 to 320 nm). Irradiation intensity lower than 1 mW/cm² requires too long a time for the reaction. By contrast, irradiation intensity exceeding 3,000 mW/cm² might cause yellowing of the photocurable adhesive or deterioration of the polarizer due to heat of radiation from the lamp and heat generated during the polymerization of the photocurable adhesive.

The light irradiation time for the photocurable adhesive is not particularly limited and set according to the composition of the photocurable adhesive, and preferably set so that the integrated quantity of light indicated by the product of irradiation intensity and irradiation time is 10 to 5000 mJ/cm². An integrated quantity of light lower than 10 mJ/cm² might insufficiently produce active species derived from the polymerization initiator, resulting in the insufficient curing of the adhesive. By contrast, an integrated quantity of light exceeding 5000 mJ/cm² requires a very long time for the irradiation and is thus disadvantageous in improving productivity.

Preferably, the photocurable adhesive is cured by irradiation with actinic radiation under conditions that do not reduce the degree of polarization, transmittance, and hue of the polarizer, the transparency of the protective film, etc.

The adhesive layer thus obtained in the polarizing plate has a thickness of, but not limited to, usually 50 μm or smaller, preferably 20 μm or smaller, even more preferably 10 or smaller, further preferably 5 μm or smaller.

Preferred examples of the photocurable adhesive for bonding the polarizer with each polarizer protective film include a photocurable adhesive composition containing the following components (α) to (δ):

(α) a cationically polymerizable compound,

(β) a cationic photoinitiator,

(γ) a photosensitizer that exhibits the maximum absorption of light having a wavelength longer than 380 nm, and

(δ) a naphthalene-based photosensitization promoter.

Cationically Polymerizable Compound (α)

The cationically polymerizable compound (α), which serves as a main component of the photocurable adhesive composition and imparts adhesion thereto as a result of polymerization and curing, can be any compound that is cured by cationic polymerization and particularly preferably contains an epoxy compound having at least two epoxy groups in the molecule. The epoxy compound includes, for example, an aromatic epoxy compound having an aromatic ring in the molecule, an alicyclic epoxy compound having, in the molecule, at least two epoxy groups, at least one of which is bound to an alicyclic ring, and an aliphatic epoxy compound having no aromatic ring in the molecule and having a ring (usually, an oxirane ring) containing an epoxy group and two carbon atoms bound thereto, one of which is bound to another aliphatic carbon atom. For the photocurable adhesive composition used in the present invention, the cationically polymerizable compound (α) is particularly preferably composed mainly of an aromatic ring-free epoxy resin, particularly, an alicyclic epoxy compound. Use of the cationically polymerizable compound composed mainly of an alicyclic epoxy compound offers a cured product having a high storage elastic modulus. A polarizing plate having the polarizer bonded with each protective film via an adhesive layer containing the cured product does not easily crack.

As described above, the alicyclic epoxy compound has, in the molecule, at least two epoxy groups, at least one of which is bound to an alicyclic ring. In this context, the phrase “epoxy group is bound to an alicyclic ring” means that, as shown in formula (V) below, two bonds of the epoxy group (—O—) are respectively bound directly to two carbon atoms (usually, adjacent carbon atoms) constituting the alicyclic ring. In formula (V), m represents an integer of 2 to 5.

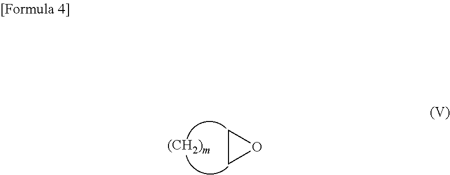

A compound in which the group of formula (V) except for one or more hydrogen atoms of (CH₂)ₘ is bound to another chemical structure can serve as the alicyclic epoxy compound. A hydrogen atom constituting the alicyclic ring may be appropriately replaced with a linear alkyl group such as a methyl or ethyl group. Among others, a compound having an epoxycyclopentane ring [represented by formula (V) where m=3] or an epoxycyclohexane ring [represented by formula (V) where m=4] is preferred.

Among these alicyclic epoxy compounds, a compound represented by any of the following formulas (V-1) to (V-11) is more preferred because the compound is easily available and largely effective for enhancing the storage elastic modulus of the cured product:

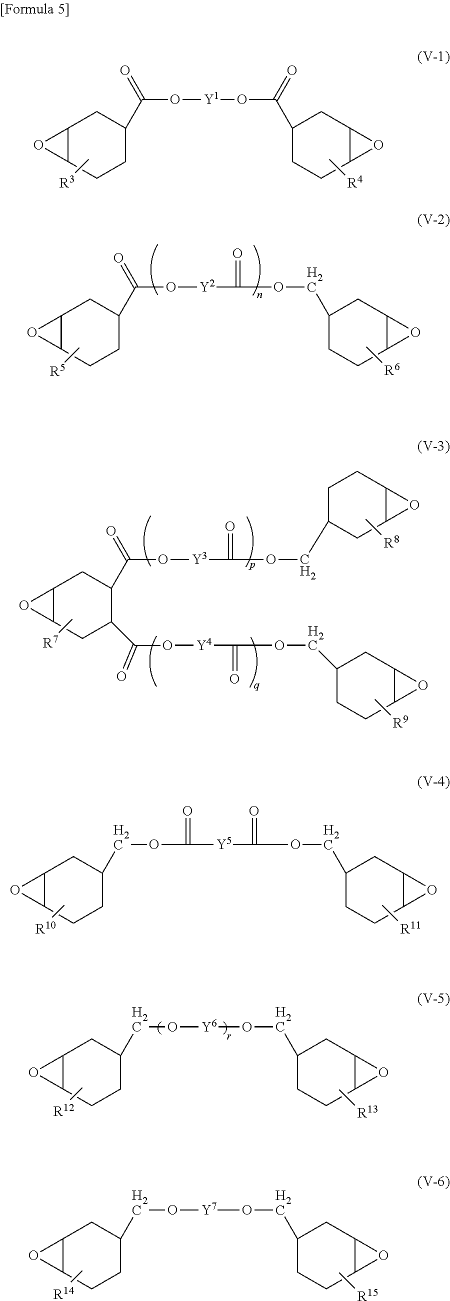

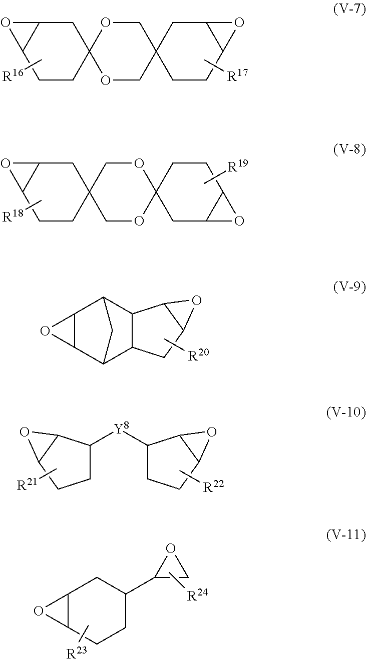

In these formulas, R¹ to R²⁴ each independently represent a hydrogen atom or a C₁₋₆ alkyl group. The alkyl group represented by any of R¹ to R²⁴ is bound at any of positions 1 to 6 to the alicyclic ring. The C₁₋₆ alkyl group may be linear or branched and may have an alicyclic ring. Y⁸ represents an oxygen atom or a C₁₋₂₀ alkanediyl group. Y¹ to Y⁷ each independently represent a C₁₋₂₀ alkanediyl group which may be linear or branched and may have an alicyclic ring. n, p, q, and r each independently represent any number of 0 to 20.

Of the compounds represented by formulas (V-1) to (V-11), the alicyclic diepoxy compound represented by formula (V-2) is preferred because the compound is easily available. The alicyclic diepoxy compound of formula (V-2) is an esterification product of 3,4-epoxycyclohexylmethanol (whose cyclohexane ring may be bound to a C₁₋₆ alkyl group) and 3,4-epoxycyclohexanecarboxylic acid (whose cyclohexane ring may be bound to a C₁₋₆ alkyl group). Specific examples thereof include the following compounds:

3,4-epoxycyclohexylmethyl 3,4-epoxycyclohexanecarboxylate [compound represented by formula (V-2) where R⁵═R⁶=H and n=0] and 3,4-epoxy-6-methylcyclohexylmethyl 3,4-epoxy-6-methylcyclohexanecarboxylate [compound represented by formula (V-2) where R⁵=6-methyl, R⁶=6-methyl, and n=0].

The alicyclic epoxy compound is also effectively used in combination with an epoxy compound substantially free from an alicyclic epoxy group. A cationically polymerizable compound that contains the alicyclic epoxy compound as a main component and further contains the epoxy compound substantially free from an alicyclic epoxy group can enhance the storage elastic modulus of the cured product and can further enhance the adherence between the polarizer and the protective film. The “epoxy compound substantially free from an alicyclic epoxy group” is preferably a compound (aliphatic epoxy compound) having a ring (usually, an oxirane ring) containing, in the molecule, an epoxy group and two carbon atoms bound thereto, one of which is bound to another aliphatic carbon atom. Examples thereof include polyglycidyl ethers of polyhydric alcohols (phenols). Among them, a diglycidyl ether compound represented by the following formula (VI) is preferred because the compound is easily available and largely effective for enhancing the adherence between the polarizer and the protective film.

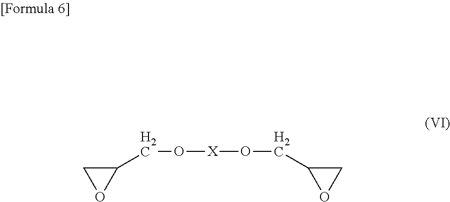

In formula (VI), X represents a direct bond, a methylene group, a C₁₋₄ alkylidene group, an alicyclic hydrocarbon group, O, S, SO₂, SS, SO, CO, OCO, or a substituent selected from the group consisting of three substituents represented by the following formulas, and the alkylidene group may be substituted by a halogen atom:

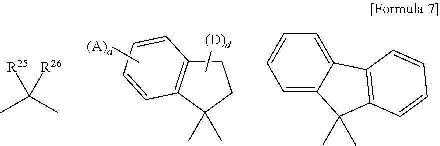

In these formulas, R²⁵ and R²⁶ each independently represent a hydrogen atom, a C₁₋₃ alkyl group, a phenyl group which may be substituted by a C₁₋₁₀ alkyl group or an alkoxy group, or a C₃₋₁₀ cycloalkyl group which may be substituted by a C₁₋₁₀ alkyl group or an alkoxy group. R²⁵ and R²⁶ may be linked to each other to form a ring. A and D each independently represent a C₁₋₁₀ alkyl group which may be substituted by a halogen atom, a C₆₋₂₀ aryl group which may be substituted by a halogen atom, a C₇₋₂₀ arylalkyl group which may be substituted by a halogen atom, a C₂₋₂₀ heterocyclic group which may be substituted by a halogen atom, or a halogen atom. A methylene group in these alkyl, aryl, and arylalkyl groups may be interrupted by an unsaturated bond, —O—, or —S—. a represents any number of 0 to 4. d represents any number of 0 to 4.

Examples of the diglycidyl ether compound of formula (VI) include: bisphenol-type epoxy resins such as diglycidyl ether of bisphenol A, diglycidyl ether of bisphenol F, and diglycidyl ether of bisphenol S; polyfunctional epoxy resins such as glycidyl ether of tetrahydroxyphenylmethane, glycidyl ether of tetrahydroxybenzophenone, and epoxidized polyvinylphenol; polyglycidyl ethers of aliphatic polyhydric alcohols; polyglycidyl ethers of alkylene oxide adducts of aliphatic polyhydric alcohols; and diglycidyl ethers of alkylene glycols. Among them, polyglycidyl ether of an aliphatic polyhydric alcohol is preferred because it is easily available.

Examples of the aliphatic polyhydric alcohol include C₂₋₂₀ aliphatic polyhydric alcohols and more specifically include: aliphatic diols such as ethylene glycol, 1,2-propanediol, 1,3-propanediol, 2-methyl-1,3-propanediol, 2-butyl-2-ethyl-1,3-propanediol, 1,4-butanediol, neopentyl glycol, 3-methyl-2,4-pentanediol, 2,4-pentanediol, 1,5-pentanediol, 3-methyl-1,5-pentanediol, 2-methyl-2,4-pentanediol, 2,4-diethyl-1,5-pentanediol, 1,6-hexanediol, 1,7-heptanediol, 3,5-heptanediol, 1,8-octanediol, 2-methyl-1,8-octanediol, 1,9-nonanediol, and 1,10-decanediol; alicyclic diols such as cyclohexanedimethanol, cyclohexanediol, hydrogenated bisphenol A, and hydrogenated bisphenol F; and trivalent or higher polyols such as trimethylolethane, trimethylolpropane, hexitols, pentitols, glycerin, polyglycerin, pentaerythritol, dipentaerythritol, and tetramethylolpropane.

The alicyclic epoxy compound and the epoxy compound substantially free from an alicyclic epoxy group can be used in combination at a mixing ratio of preferably 50 to 95 wt % of the alicyclic epoxy compound and 5 wt % or more of the epoxy compound substantially free from an alicyclic epoxy group with respect to the total amount of the cationically polymerizable compound. The cationically polymerizable compound containing 50 wt % or more of the alicyclic epoxy compound with respect to the total amount thereof offers a cured product having a storage elastic modulus of 1,000 MPa or larger at 80° C. A polarizing plate having the polarizer bonded with the protective film via an adhesive layer containing such a cured product is difficult to crack. The cationically polymerizable compound containing 5 wt % or more of the epoxy compound substantially free from an alicyclic epoxy group with respect to the total amount thereof improves the adherence between the polarizer and the protective film. The cationically polymerizable compound consisting of two components, i.e., the alicyclic epoxy compound and the epoxy compound substantially free from an alicyclic epoxy group, can contain 50 wt % of the epoxy compound substantially free from an alicyclic epoxy group with respect to the total amount thereof and preferably contains 45 wt % or less of the epoxy compound substantially free from an alicyclic epoxy group with respect to the total amount thereof for preventing the resulting polarizing plate from being cracked due to a low storage elastic modulus of the cured product.

In the case of using the alicyclic epoxy compound and the epoxy compound substantially free from an alicyclic epoxy group in combination as the cationically polymerizable compound (α) constituting the photocurable adhesive composition, the component (α) may further contain an additional cationically polymerizable compound so that the amounts of these epoxy compounds fall within the respective ranges described above. Examples of the additional cationically polymerizable compound include epoxy compounds other than the compounds of formulas (V-1) to (V-11) and (VI), and oxetane compounds.

The epoxy compounds other than the compounds of formulas (V-1) to (V-11) and (VI) can be alicyclic epoxy compounds other than the compounds of formulas (V-1) to (V-11), aliphatic epoxy compounds other than the compounds of formula (VI), aromatic epoxy compounds, aromatic epoxy compounds having a hydrogenated aromatic ring (hydrogenated epoxy compounds), or the like.

Examples of the alicyclic epoxy compounds other than the compounds of formulas (V-1) to (V-11) include 4-vinylcyclohexene diepoxide and diepoxides of vinylcyclohexenes such as 1,2:8,9-diepoxylimonene.

Examples of the aliphatic epoxy compounds other than the compounds of formula (VI) include triglycidyl ether of glycerin, triglycidyl ether of trimethylolpropane, and diglycidyl ether of polyethylene glycol.

The aromatic epoxy compounds can be glycidyl ethers of aromatic polyhydroxy compounds each having at least two phenolic hydroxy groups in the molecule. Specific examples thereof include diglycidyl ether of bisphenol A, diglycidyl ether of bisphenol F, diglycidyl ether of bisphenol S, and glycidyl ether of phenol novolac resin.

The aromatic epoxy compounds having a hydrogenated aromatic ring (hydrogenated epoxy compounds) can be glycidyl etherification products of hydrogenated polyhydroxy compounds obtained through the selective hydrogenation reaction of aromatic polyhydroxy compounds (which are starting materials for the aromatic epoxy compounds described above) each having at least two phenolic hydroxy groups in the molecule under pressure in the presence of a catalyst. Specific examples thereof include diglycidyl ether of hydrogenated bisphenol A, diglycidyl ether of hydrogenated bisphenol F, and diglycidyl ether of hydrogenated bisphenol S.

The epoxy compounds other than the compounds of formulas (V-1) to (V-11) and (VI) may be alicyclic epoxy compounds. In such a case, it is preferred that the total sum of the alicyclic epoxy compound and the alicyclic epoxy compound represented by any of formulas (V-1) to (V-11) should not exceed 95 wt % with respect to the total amount of the cationically polymerizable compound.

The oxetane compound that may serve as the optional cationically polymerizable compound can be a compound having 4-membered ring ether (oxetanyl group) in the molecule. Specific examples thereof include the following compounds:
3-ethyl-3-hydroxymethyloxetane,
1,4-bis[(3-ethyl-3-oxetanyl)methoxymethyl]benzene,
3-ethyl-3-(phenoxymethyl)oxetane,
di [(3-ethyl-3-oxetanyl)methyl]ether,
3-ethyl-3-(2-ethylhexyloxymethyl)oxetane,
3-ethyl-3-(cyclohexyloxymethyl)oxetane,
phenol novolac oxetane,
1,3-bis[(3-ethyloxetan-3-yl)methoxy]benzene,
oxetanyl silsesquioxane, and
oxetanyl silicate.

The cationically polymerizable compound further containing 30 wt % or less of the oxetane compound with respect to the total amount thereof can enhance the curability of the photocurable adhesive, compared with the cationically polymerizable compound containing only the epoxy compounds.

Cationic Photoinitiator (β)

The cationically polymerizable compound is cationically polymerized and cured by irradiation with actinic radiation to form an adhesive layer. Thus, the photocurable adhesive composition contains a cationic photoinitiator (β).

Upon irradiation with actinic radiation such as visible rays, UV rays, X-rays, or electron beams, the cationic photoinitiator generates cationic species or Lewis acid to start the polymerization reaction of the cationically polymerizable compound (cc). The cationic photoinitiator acts catalytically by light and is therefore excellent in storage stability and workability even after being mixed with the cationically polymerizable compound (α). Examples of such a compound that generates cationic species or Lewis acid upon irradiation with actinic radiation include: aromatic diazonium salts; onium salts such as aromatic iodonium salts and aromatic sulfonium salts; and iron-allene complexes.

Examples of the aromatic diazonium salts include the following compounds:
benzenediazonium hexafluoroantimonate,
benzenediazonium hexafluorophosphate, and
benzenediazonium hexafluoroborate.

Examples of the aromatic iodonium salts include the following compounds:
diphenyliodonium tetrakis(pentafluorophenyl)borate,
diphenyliodonium hexafluorophosphate,
diphenyliodonium hexafluoroantimonate, and
di(4-nonylphenyl)iodonium hexafluorophosphate.

Examples of the aromatic sulfonium salts include the following compounds:
triphenylsulfonium hexafluorophosphate,
triphenylsulfonium hexafluoroantimonate,
triphenylsulfonium tetrakis(pentafluorophenyl)borate,
4,4′-bis[diphenylsulfonio]diphenylsulfide bishexafluorophosphate,
4,4′-bis[di(β-hydroxyethoxy)phenylsulfonio]diphenylsulfide bishexafluoroantimonate,
4,4′-bis[di(β-hydroxyethoxy)phenylsulfonio]diphenylsulfide bishexafluorophosphate,
7-[di(p-toluoyl)sulfonio]-2-isopropylthioxanthone hexafluoroantimonate,
7-[di(p-toluoyl)sulfonio]-2-isopropylthioxanthone tetrakis(pentafluorophenyl)borate,
4-phenylcarbonyl-4′-diphenylsulfonio-diphenylsulfide hexafluorophosphate,
4-(p-tert-butylphenylcarbonyl)-4′-diphenylsulfonio-diphenylsulfide hexafluoroantimonate, and
4-(p-tert-butylphenylcarbonyl)-4′-di(p-toluoyl)sulfonio-diphenylsulfide tetrakis(pentafluorophenyl)borate.

Examples of the iron-allene complexes include the following compounds:
xylene-cyclopentadienyl iron(II) hexafluoroantimonate,
cumene-cyclopentadienyl iron(II) hexafluorophosphate, and
xylene-cyclopentadienyl iron(II) tris(trifluoromethylsulfonyl)methanide

These cationic photoinitiators (β) may be used alone or as a mixture of two or more types. Among them, an aromatic sulfonium salt is particularly preferably used because this salt has UV ray-absorbing properties even in a wavelength region near 300 nm and can therefore offer a cured product that is excellent in curability and has favorable mechanical strength and bond strength.

The content of the cationic photoinitiator (β) can be set to 1 to 10 parts by weight with respect to 100 parts by weight of the cationically polymerizable compound (α). The cationically polymerizable compound (α) mixed with 1 part by weight or higher of the cationic photoinitiator with respect to 100 parts by weight of the cationically polymerizable compound (α) can be sufficiently cured and imparts high mechanical strength and bond strength to the resulting polarizing plate. By contrast, a larger content of the cationic photoinitiator (β) increases the amount of ionic substances in a cured product. The resulting cured product is highly hygroscopic and might therefore reduce the durability of the polarizing plate. Thus, the content of the cationic photoinitiator (β) can be set to 10 parts by weight or lower with respect to 100 parts by weight of the cationically polymerizable compound (α). The content of the cationic photoinitiator (β) is preferably 2 parts by weight or higher, more preferably 6 parts by weight or lower, with respect to 100 parts by weight of the cationically polymerizable compound (α).

Photosensitizer (γ)

The photocurable adhesive composition further contains a photosensitizer (γ) that exhibits the maximum absorption of light having a wavelength longer than 380 nm, in addition to the cationically polymerizable compound (α) and the cationic photoinitiator (β). The cationic photoinitiator (β) exhibits the maximum absorption at a wavelength near or shorter than 300 μm. Upon sensitization with light having a wavelength in such a region, the cationic photoinitiator (β) generates cationic species or Lewis acid to start the cationic polymerization of the cationically polymerizable compound (α). The cationic photoinitiator (β) is mixed with the photosensitizer (γ) that exhibits the maximum absorption of light having a wavelength longer than 380 nm so that the resulting cationic photoinitiator (β) can also be sensitized with light having a longer wavelength. An anthracene-based compound represented by formula (III) below is advantageously used as such a photosensitizer (γ). In formula (III), R⁵ and R⁶ each independently represent a C₁₋₆ alkyl group or a C₂₋₁₂ alkoxyalkyl group. R⁷ represents a hydrogen atom or a C₁₋₆ alkyl group.

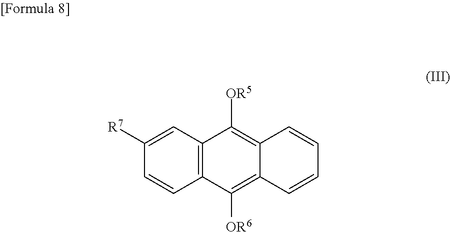

Specific examples of the anthracene-based compound represented by formula (III) include the following compounds:
9,10-dimethoxyanthracene,
9,10-diethoxyanthracene,
9,10-dipropoxyanthracene,
9,10-diisopropoxyanthracene,
9,10-dibutoxyanthracene,
9,10-dipentyloxyanthracene,
9,10-dihexyloxyanthracene,
9,10-bis(2-methoxyethoxy)anthracene,
9,10-bis(2-ethoxyethoxy)anthracene,
9,10-bis(2-butoxyethoxy)anthracene,
9,10-bis(3-butoxypropoxy)anthracene,
2-methyl- or 2-ethyl-9,10-dimethoxyanthracene,
2-methyl- or 2-ethyl-9,10-diethoxyanthracene,
2-methyl- or 2-ethyl-9,10-dipropoxyanthracene,
2-methyl- or 2-ethyl-9,10-diisopropoxyanthracene,
2-methyl- or 2-ethyl-9,10-dibutoxyanthracene,
2-methyl- or 2-ethyl-9,10-dipentyloxyanthracene, and
2-methyl- or 2-ethyl-9,10-dihexyloxyanthracene.

The photocurable adhesive composition containing the photosensitizer (γ) as described above has higher curability than that of a photocurable adhesive composition free from the photosensitizer (γ). The content of the photosensitizer (γ) can be set to 0.1 parts by weight or higher with respect to 100 parts by weight of the cationically polymerizable compound (α) in order to obtain sufficient curability. By contrast, too large a content of the photosensitizer (γ) may be deposited during low-temperature storage. Thus, the content of the photosensitizer (γ) can be set to 2 parts by weight or lower with respect to 100 parts by weight of the cationically polymerizable compound (α). For maintaining the neutral gray of the polarizing plate, it is preferred to reduce the amount of the photosensitizer (γ) mixed to an extent where the adhesion between the polarizer and the protective film is kept moderate. For example, the content of the photosensitizer (γ) is preferably 0.1 to 0.5 parts by weight, more preferably 0.1 to 0.3 parts by weight, with respect to 100 parts by weight of the cationically polymerizable compound (α).

Naphthalene-Based Photosensitization Promoter (δ)

The photocurable adhesive composition further contains a naphthalene-based photosensitization promoter (δ) represented by formula (IV) below, in addition to the cationically polymerizable compound (α), the cationic photoinitiator (β), and the photosensitizer (γ). In formula (IV), R¹ and R² each represent a C₁₋₆ alkyl group.

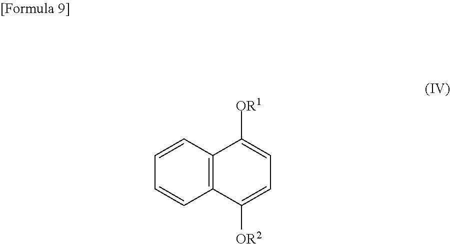

Specific examples of the naphthalene-based photosensitization promoter (δ) include the following compounds:
1,4-dimethoxynaphthalene,
1-ethoxy-4-methoxynaphthalene,
1,4-diethoxynaphthalene,
1,4-dipropoxynaphthalene, and
1,4-dibutoxynaphthalene.

The photocurable adhesive composition containing the naphthalene-based photosensitization promoter (δ) has higher curability than that of a photocurable adhesive composition free from the naphthalene-based photosensitization promoter (δ). The content of the naphthalene-based photosensitization promoter (δ) can be set to 0.1 parts by weight or higher with respect to 100 parts by weight of the cationically polymerizable compound (α) in order to obtain sufficient curability. By contrast, a larger content of the naphthalene-based photosensitization promoter (δ) may be deposited during low-temperature storage. Thus, its amount can be set to 10 parts by weight or lower with respect to 100 parts by weight of the cationically polymerizable compound (α). The content of the naphthalene-based photosensitization promoter (δ) is preferably 5 parts by weight or lower with respect to 100 parts by weight of the cationically polymerizable compound (α).

The photocurable adhesive composition may further contain an additive as an optional additional component without impairing the effects of the present invention. The additive can be a photosensitizer other than the cationic photoinitiator (β) and the photosensitizer (γ) described above, a cationic thermal initiator, a polyol, an ion trapping agent, an antioxidant, a light stabilizer, a chain transfer agent, a tackifier, a thermoplastic resin, a filler, a flow adjuster, a plasticizer, an antifoaming agent, a leveling agent, a dye, an organic solvent, or the like.

The photocurable adhesive composition containing the additive has its content of preferably 1000 parts by weight or lower with respect to 100 parts by weight of the cationically polymerizable compound (α). The content of 1000 parts by weight or lower rarely impairs the effects of improving storage stability, preventing change in color, improving a curing rate, and securing favorable adhesion by the cationically polymerizable compound (α), the cationic photoinitiator (β), the photosensitizer (γ), and the photosensitization promoter (δ), which are essential components of the photocurable adhesive composition.

Preferred another example of the adhesive for bonding the polarizer to each polarizer protective film includes a photocurable adhesive composition essentially containing the following epoxy compound (α1), oxetane compound (a2), and cationic photoinitiator (β1):

(α1) an epoxy compound having at least two epoxy groups in the molecule,

(α2) an oxetane compound having at least one oxetanyl group in the molecule, and

(β1) a cationic photoinitiator.

Preferably, the mass ratio between the epoxy compound (α1) and the oxetane compound (α2) is set to on the order of (α1)/(α2)=90/10 to 10/90. The content of the radical photoinitiator (β1) is preferably approximately 0.5 to 20 wt % in the composition.

This photocurable adhesive composition can further contain an unsaturated compound (∈) having at least one ethylenic unsaturated bond in the molecule. In this case, preferably, the photocurable adhesive composition further contains a radical photoinitiator (ξ). This photocurable adhesive composition may further contain a nonpolymerizable additional component (F).

Epoxy Compound (α1)

The epoxy compound (α1) in the photocurable adhesive composition can be any compound that has at least two epoxy groups in the molecule, without limitations. Generally known various curable epoxy compounds can be used. Preferred examples of the epoxy compound (α1) include compounds (aromatic epoxy compounds) each having at least two epoxy groups and at least one aromatic ring in the molecule, and compounds (alicyclic epoxy compounds) each having, in the molecule, at least two epoxy groups, at least one of which is formed between two adjacent carbon atoms constituting an alicyclic ring.

Examples of the aromatic epoxy compounds include, but not limited to:
bisphenol-type epoxy resins such as diglycidyl ether of bisphenol A, diglycidyl ether of bisphenol F, and diglycidyl ether of brominated bisphenol A;
novolac-type epoxy resins such as phenol novolac-type epoxy resins and cresol novolac-type epoxy resins; and
other epoxy compounds such as biphenyl-type epoxy resins, hydroquinone diglycidyl ether, resorcin diglycidyl ether, terephthalic acid diglycidyl ester, phthalic acid diglycidyl ester, epoxidation products of styrene-butadiene copolymers, epoxidation products of styrene-isoprene copolymers, and addition reaction products of carboxylic acid-terminated polybutadiene and bisphenol A-type epoxy resin.

The epoxy resin refers to a compound (including a monomer, an oligomer, and a polymer) that has two or more epoxy groups on average in the molecule and is cured through reaction.

Examples of the alicyclic epoxy compounds include, but not limited to, compounds each having at least one epoxidized cyclohexyl group, such as dicyclopentadiene dioxide, limonene dioxide, 4-vinylcyclohexene dioxide, 3,4-epoxycyclohexylmethyl 3,4-epoxycyclohexanecarboxylate, and bis(3,4-epoxycyclohexylmethyl) adipate.

Examples of the epoxy compound (α1) also include: aliphatic epoxy compounds such as 1,6-hexanediol diglycidyl ether, trimethylolpropane triglycidyl ether, pentaerythritol tetraglycidyl ether, and polytetramethylene glycol diglycidyl ether; epoxy compounds having a hydrogenated aromatic ring, such as diglycidyl ether of hydrogenated bisphenol A; and polymeric epoxy compounds such as hydroxyl-terminated (on both sides) polybutadiene compounds having both glycidyl etherified ends, internal epoxidation products of polybutadiene, styrene-butadiene copolymer compounds having partially epoxidized double bonds [e.g., “Epofriend” manufactured by Daicel Corp.], and polyisoprene block copolymer compounds of ethylene-butylene copolymers having partially epoxidized isoprene units (e.g., “L-207” manufactured by Kraton Polymers).

Among them, an aromatic epoxy compound is preferred because this compound can impart favorable durability to the polarizing plate and further offer the favorable adhesion between the polarizer and the protective film. Preferred examples of the aromatic epoxy compound include glycidyl ethers of aromatic compounds and glycidyl esters of aromatic compounds. Specific examples of the glycidyl ethers of aromatic compounds preferably include: bisphenol-type epoxy resins such as diglycidyl ether of bisphenol A, diglycidyl ether of bisphenol F, and diglycidyl ether of brominated bisphenol A; novolac-type epoxy resins such as phenol novolac-type epoxy resins and cresol novolac-type epoxy resins; biphenyl-type epoxy resins; hydroquinone diglycidyl ether; and resorcin diglycidyl ether. Specific examples of the glycidyl esters of aromatic compounds preferably include terephthalic acid diglycidyl ester and phthalic acid diglycidyl ester.

Among them, glycidyl ether of an aromatic compound is particularly preferred because of the favorable adherence between the polarizer and the protective film and the favorable durability of the polarizing plate. The glycidyl ether of an aromatic compound can be preferably diglycidyl ether of bisphenol A, diglycidyl ether of bisphenol F, or a phenol novolac-type epoxy resin.

These epoxy compounds (α1) may be used alone or as a mixture of two or more types. For example, the epoxy compound (α1) may be a mixture of two or more types of aromatic epoxy compounds or may be a mixture of an aromatic epoxy compound (main component) and an alicyclic epoxy compound.

Oxetane Compound (α2)

The oxetane compound (α2) in the photocurable adhesive composition can be any compound that has at least one oxetanyl group in the molecule, without limitations. Preferred examples of the oxetane compound (α2) include compounds having one oxetanyl group in the molecule (monofunctional oxetanes), and compounds having two or more oxetanyl groups in the molecule (polyfunctional oxetanes).

Examples of the monofunctional oxetanes include: alkoxyalkyl group-containing monofunctional oxetanes such as 3-ethyl-3-(2-ethylhexyloxymethyl)oxetane; aromatic group-containing monofunctional oxetanes such as 3-ethyl-3-phenoxymethyloxetane; and hydroxy group-containing monofunctional oxetanes such as 3-ethyl-3-hydroxymethyloxetane.

Examples of the polyfunctional oxetanes include the following compounds:
3-ethyl-3-[(3-ethyloxetan-3-yl)methoxymethyl]oxetane,
1,4-bis[(3-ethyloxetan-3-yl)methoxymethyl]benzene,
1,4-bis[(3-ethyloxetan-3-yl)methoxy]benzene,
1,3-bis[(3-ethyloxetan-3-yl)methoxy]benzene,
1,2-bis[(3-ethyloxetan-3-yl)methoxy]benzene,
4,4′-bis[(3-ethyloxetan-3-yl)methoxy]biphenyl,
2,2′-bis[(3-ethyloxetan-3-yl)methoxy]biphenyl,
3,3′,5,5′-tetramethyl-4,4′-bis[(3-ethyloxetan-3-yl)methoxy]biphenyl,
2,7-bis[(3-ethyloxetan-3-yl)methoxy]naphthalene,
bis[4-{(3-ethyloxetan-3-yl)methoxy}phenyl]methane,
bis[2-{(3-ethyloxetan-3-yl)methoxy}phenyl]methane, 2,2-bis[4-{(3-ethyloxetan-3-yl)methoxy}phenyl]propane,
ether-modified products of novolac-type phenol-formaldehyde resins with 3-chloromethyl-3-ethyloxetane,
3(4),8(9)-bis[(3-ethyloxetan-3-yl)methoxymethyl]-tricyclo[5.2.1.02,6]decane,
2,3-bis[(3-ethyloxetan-3-yl)methoxymethyl]norbornane,
1,1,1-tris[(3-ethyloxetan-3-yl)methoxymethyl]propane,
1-butoxy-2,2-bis[(3-ethyloxetan-3-yl)methoxymethyl]butane,
1,2-bis[{2-[3-ethyloxetan-3-yl)methoxy}ethylthio]ethane,
bis[{4-(3-ethyloxetan-3-yl)methylthio}phenyl]sulfide,
1,6-bis[(3-ethyloxetan-3-yl)methoxy]-2,2,3,3,4,4,5,5-octafluorohexane,
hydrolytic condensates of 3-[(3-ethyloxetan-3-yl)methoxy]propyltriethoxysilane, and
condensates of tetrakis [(3-ethyloxetan-3-yl)methyl]silicate.

Preferably, the oxetane compound (α2) has a molecular weight of 500 or lower and is liquid at room temperature from the viewpoint of coating properties and adherence to the protective film in the polarizing plate. Monofunctional or polyfunctional oxetane having an aromatic ring in the molecule is preferred for obtaining a polarizing plate excellent in durability. Examples of such particularly preferred oxetane compounds include 3-ethyl-3-phenoxymethyloxetane, 3-ethyl-3-[(3-ethyloxetan-3-yl)methoxymethyl]oxetane, and 1,4-bis[(3-ethyloxetan-3-yl)methoxymethyl]benzene.

These oxetane compounds (α2) may also be used alone or as a mixture of two or more types.

The ratio between the epoxy compound (α1) and the oxetane compound (α2) contained in the composition can be set to (α1)/(α2)=90/10 to 10/90 in terms of mass ratio. A ratio that falls outside the range described above makes it difficult to produce the effect of curing the photocurable adhesive composition in a short time. The ratio is preferably (α1)/(α2)=70/30 to 20/80, more preferably 60/40 to 25/75, because the resulting composition has low viscosity and excellent coating properties before curing and exhibits sufficient adherence and flexibility after curing.

Cationic Photoinitiator (β1)

The photocurable adhesive composition contains the epoxy compound (α1) and the oxetane compound (α2) as curable components, which are both cured through cationic polymerization. Thus, the photocurable adhesive composition further contains a cationic photoinitiator (β1). Upon irradiation with actinic radiation such as visible rays, UV rays, X-rays, or electron beams, the cationic photoinitiator (β1) generates cationic species or Lewis acid to start the polymerization reaction of the epoxy or oxetanyl groups.

The epoxy compound (α1) and the oxetane compound (α2) mixed with the cationic photoinitiator (β1) can be cured at ordinary temperature. This can reduce the need of taking into consideration the heat resistance of the polarizer or distortion caused by expansion or contraction. The resulting composition is capable of favorably bonding the polarizer to the protective film. The cationic photoinitiator (β1) acts catalytically by irradiation with actinic radiation and is therefore excellent in storage stability or workability even after being mixed with the epoxy compound (α1) and the oxetane compound (α2). Examples of such a compound that generates cationic species or Lewis acid upon irradiation with actinic radiation include: aromatic diazonium salts; onium salts such as aromatic iodonium salts and aromatic sulfonium salts; and iron-allene complexes.

Examples of the aromatic diazonium salts include the following compounds:
benzenediazonium hexafluoroantimonate,
benzenediazonium hexafluorophosphate, and
benzenediazonium hexafluoroborate.

Examples of the aromatic iodonium salts include the following compounds:
diphenyliodonium tetrakis(pentafluorophenyl)borate,
diphenyliodonium hexafluorophosphate,
diphenyliodonium hexafluoroantimonate, and
di(4-nonylphenyl)iodonium hexafluorophosphate.

Examples of the aromatic sulfonium salts include the following compounds:
triphenylsulfonium hexafluorophosphate,
triphenylsulfonium hexafluoroantimonate,
triphenylsulfonium tetrakis(pentafluorophenyl)borate,
diphenyl[4-(phenylthio)phenyl]sulfonium hexafluorophosphate,
diphenyl[4-(phenylthio)phenyl]sulfonium hexafluoroantimonate,
4,4′-bis(diphenylsulfonio)diphenylsulfide bishexafluorophosphate,
4,4′-bis[di(β-hydroxyethoxy)phenylsulfonio]diphenylsulfide bishexafluoroantimonate,
4,4′-bis[di(β-hydroxyethoxy)phenylsulfonio]diphenylsulfide bishexafluorophosphate,
7-[di(p-toluoyl)sulfonio]-2-isopropylthioxanthone hexafluoroantimonate,
7-[di(p-toluoyl)sulfonio]-2-isopropylthioxanthone tetrakis(pentafluorophenyl)borate,
4-phenylcarbonyl-4′-diphenylsulfonio-diphenylsulfide hexafluorophosphate,
4-(p-tert-butylphenylcarbonyl)-4′-diphenylsulfonio-diphenylsulfide hexafluoroantimonate, and
4-(p-tert-butylphenylcarbonyl)-4′-di(p-toluoyl)sulfonio-diphenylsulfide tetrakis(pentafluorophenyl)borate.

Examples of the iron-allene complexes include the following compounds:
xylene-cyclopentadienyl iron(II) hexafluoroantimonate,
cumene-cyclopentadienyl iron(II) hexafluorophosphate, and
xylene-cyclopentadienyl iron(II)-tris(trifluoromethylsulfonyl)methanide.

These cationic photoinitiators ([3]) may be used alone or as a mixture of two or more types. Among them, an aromatic sulfonium salt is preferred because this salt has UV ray-absorbing properties even in a wavelength region of 300 nm or larger and can therefore offer a cured product that is excellent in curability and has favorable mechanical strength and bond strength.

The cationic photoinitiator (β1) is easily available as a commercially available product. Examples thereof include products under trade names of “Kayarad PCI-220” and “Kayarad PCI-620” (all manufactured by Nippon Kayaku Co., Ltd.), “UVI-6992” (manufactured by Dow Chemical Company), “Adeka Optomer SP-150” and “Adeka Optomer SP-170” (all manufactured by Adeka Corp.), “CI-5102”, “CIT-1370”, “CIT-1682”, “CIP-1866S”, “CIP-2048S”, and “CIP-2064S” (all manufactured by Nippon Soda Co., Ltd.), “DPI-101”, “DPI-102”, “DPI-103”, “DPI-105”, “MPI-103”, “MPI-105”, “BBI-101”, “BBI-102”, “BBI-103”, “BBI-105”, “TPS-101”, “TPS-102”, “TPS-103”, “TPS-105”, “MDS-103”, “MDS-105”, “DTS-102”, and “DTS-103” (all manufactured by Midori Kagaku Co., Ltd.), “PI-2074” (manufactured by Rhodia Japan, Ltd), “Irgacure 250”, “Irgacure PAG103”, “Irgacure PAG108”, “Irgacure PAG121”, and “Irgacure PAG203” (all manufactured by Ciba Japan K.K.), and “CPI-100P”, “CPI-101A”, “CPI-200K”, and “CPI-210S” (all manufactured by San-Apro Ltd.). Particularly, “UVI-6992” manufactured by Dow Chemical Company or “CPI-100P”, “CPI-101A”, “CPI-200K”, or “CPI-210S” manufactured by San-Apro Ltd., which contains diphenyl[4-(phenylthio)phenyl]sulfonium as a cationic component, is preferred.

The content of the cationic photoinitiator (β1) can fall within the range of 0.5 to 20 wt % with respect to the total amount of the photocurable adhesive composition. The photocurable adhesive composition having a cationic photoinitiator (β1) content lower than 0.5 wt % is insufficiently cured. The resulting cured product has low mechanical strength or bond strength. By contrast, a content exceeding 20 wt % increases the amount of ionic substances in a cured product. The resulting cured product is highly hygroscopic and might therefore reduce durability.

Unsaturated compound (∈)

The photocurable adhesive composition may further contain, if necessary, an unsaturated compound (∈) having at least one ethylenic unsaturated bond in the molecule. Typical examples of the unsaturated compound (∈) include (meth)acrylic compounds each having at least one (meth)acryloyl group in the molecule.

Examples of the (meth)acrylic compounds include (meth)acrylates, (meth)acrylamides, (meth)acrylic acid, and, (meth)acryloylmorpholine, and (meth)acrylaldehyde.

Examples of the (meth)acrylates include (meth)acrylates (monofunctional (meth)acrylates) each having one (meth)acryloyl group in the molecule, and (meth)acrylates (polyfunctional (meth)acrylates) each having two or more (meth)acryloyl groups in the molecule.

Examples of the monofunctional (meth)acrylates include the following compounds:
alkyl(meth)acrylates such as methyl(meth)acrylate, ethyl(meth)acrylate, propyl (meth)acrylate, isopropyl(meth)acrylate, butyl(meth)acrylate, isobutyl(meth)acrylate, 2-ethylhexyl(meth)acrylate, octyl(meth)acrylate, isooctyl(meth)acrylate, lauryl (meth)acrylate, and stearyl(meth)acrylate;
alicyclic monofunctional (meth)acrylates such as 2-hydroxyethyl(meth)acrylate, 2-hydroxypropyl(meth)acrylate, and 4-hydroxybutyl(meth)acrylate; alicyclic monofunctional (meth)acrylates such as cyclohexyl(meth)acrylate, isobornyl (meth)acrylate, 1,4-cyclohexanedimethylol mono(meth)acrylate, dicyclopentenyl (meth)acrylate, dicyclopentenyl(meth)acrylate, and dicyclopentenyloxyethyl (meth)acrylate;
monofunctional (meth)acrylates having an aromatic ring, such as benzyl (meth)acrylate, (meth)acrylates of p-cumylphenol alkylene oxide adducts, (meth)acrylates of o-phenylphenol alkylene oxide adducts, (meth)acrylates of phenol alkylene oxide adducts, and (meth)acrylates of nonylphenol alkylene oxide adducts (in this context, examples of the alkylene oxide include ethylene oxide and propylene oxide);
alkoxyalkyl(meth)acrylates such as 2-methoxyethyl(meth)acrylate, ethoxymethyl(meth)acrylate, and (meth)acrylates of alkylene oxide adducts of 2-ethylhexyl alcohols;
mono(meth)acrylates of dihydric alcohols, such as ethylene glycol mono(meth)acrylate, propylene glycol mono(meth)acrylate, pentanediol mono(meth)acrylate, and hexanediol mono(meth)acrylate;
mono(meth)acrylates of polyalkylene glycols, such as mono(meth)acrylate of diethylene glycol, mono(meth)acrylate of triethylene glycol, mono(meth)acrylate of tetraethylene glycol, mono(meth)acrylate of polyethylene glycol, mono(meth)acrylate of dipropylene glycol, mono(meth)acrylate of tripropylene glycol, and mono(meth)acrylate of polypropylene glycol;
glycidyl(meth)acrylate;
tetrahydrofurfuryl(meth)acrylate;
tetrahydrofurfuryl(meth)acrylates such as caprolactone-modified tetrahydrofurfuryl(meth)acrylate;
3,4-epoxycyclohexylmethyl(meth)acrylate;
N,N-dimethylaminoethyl(meth)acrylate; and
2-(meth)acryloyloxyethyl isocyanate.

Examples of the polyfunctional (meth)acrylates include the following compounds:
di(meth)acrylates having an alicyclic ring, such as tricyclodecanedimethylol di(meth)acrylate, 1,4-cyclohexanedimethylol di(meth)acrylate, norbornanedimethylol di(meth)acrylate, and di(meth)acrylate of hydrogenated bisphenol A;
di(meth)acrylates having an aromatic ring, such as di(meth)acrylates of bisphenol A alkylene oxide adducts including di(meth)acrylates of bisphenol A ethylene oxide adducts and di(meth)acrylates of bisphenol A propylene oxide adducts, and di(meth)acrylate of bisphenol A diglycidyl ether;
di(meth)acrylates of alkylene glycols, such as ethylene glycol di(meth)acrylate, propylene glycol di(meth)acrylate, pentanediol di(meth)acrylate, and hexanediol di(meth)acrylate;
di(meth)acrylates of polyalkylene glycols, such as diethylene glycol di(meth)acrylate, triethylene glycol di(meth)acrylate, tetraethylene glycol di(meth)acrylate, polyethylene glycol di(meth)acrylate, dipropylene glycol di(meth)acrylate, tripropylene glycol di(meth)acrylate, and polypropylene glycol di(meth)acrylate;
di- or tri(meth)acrylates of glycerins, such as di- or tri(meth)acrylate of glycerin and di- or tri(meth)acrylate of diglycerin;
di- or tri(meth)acrylates of alkylene oxide adducts of glycerins;
di(meth)acrylates of bisphenol alkylene oxide adducts, such as di(meth)acrylates of bisphenol A alkylene oxide adducts and di(meth)acrylates of bisphenol F alkylene oxide adducts;
polyol poly(meth)acrylates such as trimethylolpropane tri(meth)acrylate, ditrimethylolpropane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, and dipentaerythritol hexa(meth)acrylate;
poly(meth)acrylates of alkylene oxide adducts of these polyols;
di- or tri(meth)acrylates of isocyanuric acid alkylene oxide adducts; and
1,3,5-tri(meth)acryloylhexahydro-s-triazine.

Examples of the (meth)acrylamides include (meth)acrylamide, N,N-dimethyl(meth)acrylamide, N,N-diethyl(meth)acrylamide, N-methylol(meth)acrylamide, N-(3-N,N-dimethylaminopropyl)(meth)acrylamide, methylenebis(meth)acrylamide, and ethylenebis(meth)acrylamide

Alternatively, oligomers such as urethane(meth)acrylate, polyester (meth)acrylate, and epoxy(meth)acrylate may be used as the (meth)acrylic compounds.

Compounds having a (meth)acryloyl group and an ethylenic unsaturated bond other than the (meth)acryloyl group can also be used as the (meth)acrylic compounds. Specific examples thereof include allyl(meth)acrylate and N,N-diallyl(meth)acrylamide.

In addition to the (meth)acrylic compounds described above, the unsaturated compound (∈) may be, but not limited to, for example, a vinyl compound (e.g., N-vinyl-2-pyrrolidone, divinyl adipate, and divinyl sebacate), an allyl compound (e.g., triallyl isocyanurate, triallylamine, tetraallyl pyromellitate, N,N,N′,N′-tetraallyl-1,4-diaminobutane, tetraallylammonium salt, and allylamine), or an unsaturated carboxylic acid (e.g., maleic acid and itaconic acid).

The unsaturated compound (s) is particularly preferably a (meth)acrylic compound. A (meth)acrylic compound having at least one alicyclic skeleton or aromatic skeleton in the molecule is more preferred from the viewpoint of enhancing durability such as the heat resistance of the polarizing plate in which the polarizer and each protective film are bonded together via an adhesive containing that compound.

Preferred examples of the (meth)acrylic compound having at least one alicyclic skeleton or aromatic skeleton in the molecule include the monofunctional (meth)acrylates having an alicyclic ring, the monofunctional (meth)acrylates having an aromatic ring, the di(meth)acrylates having an alicyclic ring, and the di(meth)acrylates having an aromatic ring. Among them, di(meth)acrylate having a tricyclodecane skeleton is particularly preferred. Specific examples thereof include tricyclodecanedimethylol di(meth)acrylate.

The unsaturated compound (∈) can be used in order to adjust the curing rate of the photocurable adhesive composition, the adherence between the polarizer and the protective film, the modulus of elasticity of the adhesive layer, the durability of a bonded product, etc. The unsaturated compounds (∈) exemplified above may be used alone or as a mixture of two or more types.

In the case of using the photocurable adhesive composition containing the unsaturated compound (∈), its content is preferably 35 wt % or lower with respect to the total amount of the photocurable adhesive composition. The resulting composition is capable of favorably tightly bonding the polarizer to the protective film. An unsaturated compound (∈) contained in an amount exceeding 35 wt % rarely produces sufficient bond strength between the polarizer and the protective film. Thus, the content of the unsaturated compound (∈) is more preferably 30 wt % or lower, even more preferably 5 to 25 wt %, further preferably 10 to 20 wt %.

Radical Photoinitiator (ξ)

Preferably, the photocurable adhesive composition containing the unsaturated compound (∈) further contains a radical photoinitiator (ξ) for promoting the radical polymerization thereof and securing a sufficient curing rate.

Examples of the radical photoinitiator (ξ) include the following compounds:

acetophenone-based photoinitiators such as 4′-phenoxy-2,2-dichloroacetophenone, 4′-tert-butyl-2,2-dichloroacetophenone, 2,2-dimethoxy-2-phenylacetophenone, 2-methyl-1-(4-methylthiophenyl)-2-morpholinopropan-1-one, 1-hydroxycyclohexyl phenyl ketone, α,α-diethoxyacetophenone, 2-hydroxy-2-methyl-1-phenylpropan-1-one, 1-(4-isopropylphenyl)-2-hydroxy-2-methylpropan-1-one, 1-(4-dodecylphenyl)-2-hydroxy-2-methylpropan-1-one, 1-[4-(2-hydroxyethoxy)phenyl]-2-hydroxy-2-methylpropan-1-one, and 2-benzyl-2-dimethylamino-1-(4-morpholinophenyl)butan-1-one;
benzoin ether-based photoinitiators such as benzoin, benzoin methyl ether, benzoin ethyl ether, benzoin isopropyl ether, and benzoin isobutyl ether;
benzophenone-based photoinitiators such as benzophenone, methyl o-benzoylbenzoate, 4-phenylbenzophenone, 4-benzoyl-4′-methyldiphenyl sulfide, and 2,4,6-trimethylbenzophenone;
thioxanthone-based photoinitiators such as 2-isopropylthioxanthone, 2,4-diethylthioxanthone, 2,4-dichlorothioxanthone, and 1-chloro-4-propoxythioxanthone;
acylphosphine oxide-based photoinitiators such as 2,4,6-trimethylbenzoyldiphenylphosphine oxide, bis(2,6-dimethoxybenzoyl)-2,4,4-trimethylpentylphosphine oxide, and bis(2,4,6-trimethylbenzoyl)phenylphosphine oxide;
oxime/ester-based photoinitiators such as 1,2-octanedione, 1-[4-(phenylthiophenyl)], 2-(O-benzoyloxime); and
camphor quinone.

These radical photoinitiators (ξ) may be used alone or as a mixture of two or more types. In the case of using the photocurable adhesive composition containing the radical photoinitiator (ξ), its content is preferably 10 wt % or lower, more preferably 0.1 to 3 wt %, with respect to the total amount of the photocurable adhesive composition. Too large a content of the radical photoinitiator (ξ) may produce insufficient bond strength. By contrast, an adhesive having too small a content of the radical photoinitiator (ξ) is difficult to sufficiently cure.

Additional Component (η)

The photocurable adhesive composition may further contain, if necessary, an additional component (η) different from each of the components mentioned above without impairing the effects of the present invention. One example of such an additional component (η) includes a cationically polymerizable compound other than the epoxy compound (α1) or the oxetane compound (α2). Examples thereof include epoxy compounds each having one epoxy group in the molecule. Other examples of the additional component (η) include nonpolymerizable compounds. In the case of using the photocurable adhesive composition containing the nonpolymerizable compound, its content is preferably set to 10 wt % or lower with respect to the total amount of the photopolymerizable adhesive composition.

Examples of the nonpolymerizable compound include photosensitizers, cationic thermal initiators, and polyols.

The photopolymerizable adhesive composition containing a photosensitizer is highly reactive and also exhibits high mechanical strength and bond strength of a cured product. Examples of the photosensitizers include carbonyl compounds, organic sulfur compounds, persulfides, redox-based compounds, azo and diazo compounds, halogen compounds, and photoreducible dyes.

Specific examples of the photosensitizers include the following compounds:
benzoin derivatives such as benzoin methyl ether, benzoin isopropyl ether, and α,α-dimethoxy-α-phenylacetophenone;
benzophenone derivatives such as benzophenone, 2,4-dichlorobenzophenone, methyl o-benzoylbenzoate, 4,4′-bis(dimethylamino)benzophenone, and 4,4′-bis(diethylamino)benzophenone;
thioxanthone derivatives such as 2-chlorothioxanthone and 2-isopropylthioxanthone;
anthraquinone derivatives such as 2-chloroanthraquinone and 2-methylanthraquinone;
acridone derivatives such as N-methylacridone and N-butylacridone; and
other compounds such as α,α-diethoxyacetophenone, benzyl, fluorenone, xanthone, uranyl compounds, and halogen compounds.

Among the foregoing, some compounds correspond to radical photoinitiators as the component (ξ). In this context, the photosensitizer is not limited as long as the sensitizer functions to act on the cationic photoinitiator as the component (β1). These photosensitizers may be used alone or as a mixture of two or more types.

The content of the photosensitizer is preferably in the range of 0.1 to 20 parts by weight with respect to 100 parts by weight in total of the cationically polymerizable compound (compound having the epoxy compound (α1), the oxetane compound (α2), and the additional cationically polymerizable compound).

Examples of the cationic thermal initiators include benzylsulfonium salt, thiophenium salt, thiolanium salt, benzylammonium salt, pyridinium salt, hydrazinium salt, carboxylic acid ester, sulfonic acid ester, and aminimide. These initiators are easily available as commercially available products. Examples thereof include commercially available products under trade names of “Adeka Opton CP77” and “Adeka Opton CP66” (all manufactured by Adeka Corp.), “CI-2639” and “CI-2624” (all manufactured by Nippon Soda Co., Ltd.), and “San-Aid SI-60L”, “San-Aid SI-80L”, and “San-Aid SI-100L” (all manufactured by Sanshin Chemical Industry Co., Ltd.).

The polyols have the property of promoting cationic polymerization and as such, can be used as nonpolymerizable compounds. Examples of the polyols include compounds free from an acidic group other than a phenolic hydroxy group, specifically, polyol compounds free from a functional group other than a hydroxy group, polyester polyol compounds, polycaprolactone polyol compounds, polyol compounds having a phenolic hydroxy group, and polycarbonate polyol compounds.

In addition to those mentioned above, the nonpolymerizable compound may be a silane coupling agent, an ion trapping agent, an antioxidant, a light stabilizer, a chain transfer agent, a sensitizer, a tackifier, a thermoplastic resin, a filler, a flow adjuster, a plasticizer, an antifoaming agent, a leveling agent, a dye, an organic solvent, or the like. In addition to those mentioned above, the nonpolymerizable compound may be a thermoplastic resin that is added for the purpose of further improving adherence with the protective film. Preferably, the thermoplastic resin has a glass transition temperature of 70° C. or higher from the viewpoint of enhancing the durability of the polarizer. Particularly preferred examples thereof include methyl methacrylate-based polymers.

Regarding Liquid Crystal Cell 20

Liquid crystal cell 20 has two transparent substrates and a liquid crystal layer sandwiched therebetween. Liquid crystal cell 20 may have a display system such as reflective, transmissive, or semi-transmissive LCD or TN type, STN type, OCB type, HAN type, VA type (PVA or MVA type), or IPS type (also including FFS type). Among them, IPS type or the like is preferred from the viewpoint of, for example, a relative wide viewing angle.

The IPS-type liquid crystal cell has two transparent substrates, only one of which is provided with a pixel electrode for applying voltage to liquid crystals and a counter electrode corresponding thereto. In the liquid crystal cell, the transparent substrate having a pixel electrode and a counter electrode disposed thereon is preferably disposed on the backlight side (in the display apparatus). The liquid crystal layer contains liquid crystal molecules having a positive dielectric anisotropy (Δ∈>0) or a negative dielectric anisotropy (Δ∈>0). The liquid crystal molecules are oriented so that the long axis direction thereof is horizontal to the surfaces of these two transparent substrates in the absence of voltage.

The liquid crystal cell thus constituted produces an electric field in a direction horizontal to the substrate surface, between the pixel electrode and the counter electrode disposed on the one substrate. The liquid crystal molecules oriented horizontally to the substrate surface are thereby rotated in a plane horizontal to the substrate surface. As a result, the liquid crystal layer is driven to display images with the transmittance and reflectance of each sub-pixel changed.

The liquid crystal display device is susceptible to blank (egg-shaped blur) or the like on or near the rim of the screen. The cause of this egg-shaped blur is not definitely clear. A stress attributed to the contraction of polarizer is also applied to a polarizer protective film adjacent thereto when the display apparatus is left in hot and humid conditions. In hot and humid conditions, the backlight unit may be deformed and contacted (the contact portion is oval in plan), at the central portion of the screen, with the polarizing plate to apply stress to the polarizer protective film. The polarizer protective film placed under such stress tends to generate birefringence and is therefore prone to light leakage. A possible cause of egg-shaped blur will now be described. The contact portion between the backlight unit and polarizing plate retains moisture, whereas a non-contact portion is less likely to retain moisture and thus drying progresses. Accordingly, the manner by which moisture dries changes significantly at the boundary between the contact portion and non-contact portion. Here, there are two possible causes of the occurrence of a contact between the backlight unit and polarizing plate. The first possible cause is that the diffuser of the backlight unit swells and bulges toward the liquid crystal cell's side when exposed to high-humidity conditions. The second possible cause is that because recent liquid crystal cells are becoming larger and thinner, the liquid crystal cell bends while it is dried after placed in high-humidity conditions thus increasing the likelihood of the occurrence of a contact between the polarizing plate of the liquid crystal cell and the backlight unit. These factors, either individually or combined in a complex manner, would contribute to the occurrence of the above-described contact and therefore egg-shaped blur. For the polarizer protective film of the polarizing plate on the backlight side, which polarizer protective film is placed on the liquid crystal cell's side, the cause of egg-shaped blur would be attributed to a contact between the diffuser of the backlight unit and liquid crystal cell, which is caused by the above-described environmental changes. The manner by which moisture, absorbed by the polarizing plate, dries changes particularly at the boundary between the contact portion and non-contact portion; the moisture retention condition thus changes, resulting in changes in the manner by which stress is applied. Changes in birefringence occur due to changes in moisture retention conditions. Changes in the manner by which stress is applied due to changes in the moisture retention conditions lead to changes in the degree of photoelasticity development. These factors would contribute to changes in birefringence in the polarizer protective film, resulting in the generation of light leakage that leads to blur in the image. The contact portion at this time has an oval shape and therefore is called egg-shaped blur. A feature of the present invention lies in the fact that when changes in birefringence associated with environmental changes and changes in the degree of photoelasticity development caused by stress application are within the claimed ranges for the polarizer protective film of the polarizing plate on the backlight side, which polarizer protective film is placed on the liquid crystal cell's side, influences caused by changes in birefringence and photoelasticity that affect images are minimized. Even when a contact occurs between the diffuser of the backlight unit and liquid crystal cell due to the above-described environmental changes, it would be possible to reduce or eliminate blur in the image as well as blur at the boundary between the contact portion and non-contact portion.

Particularly, polarizer protective films 46 (F2) and 64 (F3) constituting the IPS-type liquid crystal display device each have in-plane retardation R₀ usually set to zero or near zero in the absence of stress. Thus, birefringence that occurs, even if only slightly, in the polarizer protective film F2 or F3 by the application of stress makes light leakage outstanding. Such light leakage further tends to occur in liquid crystal display devices having a large screen of 30 inch or larger, particularly 30 to 54 inch.

The liquid crystal display device of the present invention includes the polarizer protective film of the present invention as at least one of polarizer protective films 46 (F2) and 64 (F3), preferably as polarizer protective film 64 (F3). As a result, the generation of egg-shaped blur is limited, particularly in hot and humid conditions.

### EXAMPLES

Hereinafter, the present invention will be described in more detail with reference to Examples. The scope of the present invention should not be interpreted in a limited manner by these Examples.

### Example 1

Components listed below were fully dissolved with heating to prepare dope solution 1.

(Composition of Dope Solution 1)

Dianal BR85 (manufactured by Mitsubishi Rayon Co., Ltd., acrylic resin): 70 parts by mass

Cellulose acetate propionate (total degree of acyl substitution: 2.75, degree of acetyl substitution: 0.20, degree of propionyl substitution: 2.55, Mw=200000): 30 parts by mass

Methylene chloride: 300 parts by mass

Ethanol: 40 parts by mass

The prepared dope solution was uniformly casted at a width of 2 m onto a stainless-band support at a temperature of 22° C. using a belt casting apparatus. The solvents in the dope film on the stainless-band support were evaporated until the amount of residual solvents became 100%. Then, the resulting web was peeled from the stainless-band support at a peeling tension of 162 N/m. The obtained web was dried at 35° C. to further evaporate the solvents. Then, the resulting web was slit into a width of 1.5 m. The obtained web was dried at a drying temperature of 140° C. while stretched 1.05 times (5%) in the width direction (stretching direction: T) using a tenter. The web had 10% residual solvents at the start of stretching using a tenter.

The web thus stretched using a tenter was relaxed at 130° C. for 5 minutes and further dried while conveyed through a drying zone of 120° C. by a large number of rolls. The obtained film was slit into a width of 1.5 m. Both ends of the film were knurled (width: 10 mm, height: 5 μm). Then, the obtained film was wound around a core having an inner diameter of 15.24 cm at an initial tension of 220 N/m and a final tension of 110 N/m to obtain a roll sample of polarizer protective film 1 having a thickness of 40 μm and a length of 5200 m.

### Examples 2 to 4

Polarizer protective films 2 to 4 having a thickness of 40 μm were prepared in the same way as in Example 1 except that the composition of the dope and the web stretch ratio were changed as listed in Table 1.

### Example 5

Components listed below were fully dissolved with heating to prepare dope solution 5.

(Composition of Dope Solution 5)

Dianal BR85 (manufactured by Mitsubishi Rayon Co., Ltd.): 90 parts by mass

Cellulose acetate propionate (total degree of acyl substitution: 2.75, degree of acetyl substitution: 0.20, degree of propionyl substitution: 2.55, Mw=200000): 10 parts by mass

Methylene chloride: 300 parts by mass

Ethanol: 40 parts by mass

The prepared dope solution was uniformly casted at a width of 2 m onto a stainless-band support at a temperature of 22° C. using a belt casting apparatus. The solvents in the dope film on the stainless-band support were evaporated until the amount of residual solvents became 100%. Then, the obtained web was peeled from the stainless-band support using a peeling roll at a peeling tension of 180 N/m. The obtained web was stretched in the MD direction at a conveying tension of 200 N/m while the solvents were evaporated at 60° C. Then, the resulting web was slit into a width of 1.6 m and conveyed to a tenter (TD stretching step). The stretch ratio in the conveying direction (stretching direction: M) from the peeling roll to a roll at which the stretching step in the TD direction started was 20%.

Then, the web was dried at a drying temperature of 140° C. with its width direction kept using a tenter. The web had 10% residual solvents at the start of stretching using a tenter. The web thus stretched using a tenter was relaxed at 130° C. for 5 minutes and further dried while conveyed through a drying zone of 120° C. by a large number of rolls. The obtained film was slit into a width of 1.5 m. Both ends of the film were knurled (width: 10 mm, height: 5 μm). Then, the obtained film was wound around a core having an inner diameter of 15.24 cm at an initial tension of 220 N/m and a final tension of 110 N/m to obtain a roll sample of polarizer protective film 5 having a thickness of 40 μm and a length of 5200 m.

### Examples 6 to 8

Polarizer protective films 6 to 8 were prepared in the same way as in Example 5 except that the composition of the dope solution and the web stretch ratio were changed as shown in Table 1.

TABLE 1

| | Composition of resin | | | |
|---|---|---|---|---|
| | Acrylic resin | Cellulose ester | Stretching condition | |
| Film | BR85 | resin CAP | Stretching | Stretch ratio |
| No. | [part by mass] | [part by mass] | direction | [%] |
| 1 | 70 | 30 | T | 5 |
| 2 | 70 | 30 | T | 10 |
| 3 | 75 | 25 | T | 10 |
| 4 | 75 | 25 | T | 20 |
| 5 | 90 | 10 | M | 20 |
| 6 | 80 | 20 | M | 10 |
| 7 | 60 | 40 | M | 10 |
| 8 | 60 | 40 | M | 30 |

### Example 9

A 1000-L reaction vessel equipped with a stirring apparatus, a thermometer, a cooler, and a nitrogen inlet was charged with 40 parts by mass of methyl methacrylate, 10 parts by mass of methyl 2-(hydroxymethyl)acrylate, 50 parts by mass of toluene, and 0.025 parts by mass of ADK STAB 2112 (manufactured by Adeka Corp.). This solution was heated to reflux to 105° C. while doped with nitrogen. To this solution, 0.05 parts by mass of each of a polymerization initiator and t-amyl peroxyisononanoate (manufactured by ATOFINA Yoshitomi, Ltd., trade name: Lupasol 570) were added. The mixture was subjected to solution polymerization under reflux (approximately 105 to 110° C.) while 0.10 parts by mass of t-amyl peroxyisononanoate were further added dropwise thereto over 2 hours, followed by aging over 4 hours. To the obtained polymer solution, 0.05 parts by mass of stearyl phosphate (manufactured by Sakai Chemical Industry Co., Ltd., trade name: Phoslex A-18) were added, and the mixture was subjected to cyclocondensation reaction under reflux (approximately 90 to 110° C.) for 2 hours. The polymer solution thus obtained through cyclocondensation reaction was passed through a multi-tube heat exchanger heated to 240° C. to complete the cyclocondensation reaction.

The obtained polymer was introduced at a processing speed of 20 kg/hour (in terms of the amount of resin) to a vent-type twin-screw extruder (φ=44 mm, L/D=52.5) having a barrel temperature of 240° C., the number of revolutions of 120 rpm, a degree of pressure reduction of 13.3 to 400 hPa, one rear vent, four front vents (referred to as the first, second, third, and fourth vents from upstream to downstream), and a side feeder between the third vent and the fourth vent. The polymer was devolatized. During this operation, a mixed solution containing an antioxidant and a deactivator, which was separately prepared in advance, was injected at an injection rate of 0.3 kg/hour to the polymer from the third vent using a high-pressure pump. The mixed solution containing an antioxidant and a deactivator was prepared by dissolving 50 parts by mass of ADK STAB AO-60 (manufactured by Adeka Corp.) and 40 parts by mass of zinc octoate (manufactured by Nihon Kagaku Sangyo Co., Ltd., Nikka Octhix Zinc 3.6%) in 210 parts by mass of toluene. Also, ion-exchanged water was injected thereto at an injection rate of 0.33 kg/hour from each of the second and fourth vents using a high-pressure pump.

In addition, AS resin (manufactured by Asahi Kasei Chemicals Corp., trade name: Stylac AS783L) was added thereto at a feed rate of 2.12 kg/hour from the side feeder. Then, the melt-kneaded resin was filtered through a leaf-disk polymer filter (manufactured by Nagase & Co., Ltd., nominal filtration rating: 5 μm).

A pellet of lactone ring-containing polymer composition (A-1) was obtained through the devolatilization and filtration steps. The lactone ring-containing polymer composition (A-1) had a weight-average molecular weight of 132000 and a glass transition temperature of 125° C.

The obtained pellet of composition (A-1) was melt-extruded from a coat hanger-type T-die (width: 150 mm) at 280° C. using a single-screw extruder (φ=20 mm, L/D=25) and discharged onto a cooling roll having a temperature of 110° C. to prepare unstretched film (B-1) having a thickness of 198 μm.

The obtained unstretched film (B-1) was cut into a size of 96 mm×96 mm and then, sequentially biaxially stretched at a stretch ratio of 2.2 times in the longitudinal and transverse directions (MD and TD directions) of the film in the order named at 150° C. at a rate of 800 mm/minute using a sequential biaxial stretching machine (manufacturing Toyo Seiki Seisaku-Sho, Ltd., X-6S). The film thus stretched was immediately taken out of the test apparatus and cooled to obtain polarizer protective film 9 having a thickness of 36 μm.

### Example 10

Lactone ring-containing polymer composition (A-2) was prepared in the same way as in Example 9 except that the AS resin was added thereto at a feed rate of 1.5 kg/hour from the side feeder. Then, polarizer protective film 10 was prepared.

### Comparative Example 1

Z-TAC film (manufactured by Fujifilm Corp.) was prepared and used as polarizer protective film 11.

Polarizer protective films 1 to 11 thus obtained were subjected to the measurement of in-plane retardation R₀, thickness retardation Rt, tensile stress under which birefringence Δn (=nx−ny) becomes 0, and photoelastic coefficient c according to the following methods:

Measurement of in-plane retardation R₀ and thickness retardation Rt

Each film was left for 24 hours in an environment of 23° C. and 55% RH, and the retardations R₀(589) and Rt(589) of the film at a wavelength of 589 nm were measured in the same environment as above using an automatic birefringence meter KOBRA-21ADH (manufactured by Oji Scientific Instruments).

Measurement of stress under which birefringence Δn becomes 0

Each obtained film was left for 24 hours in an environment of 50° C. and 80% RH, and the in-plane retardation R₀ of the film at a wavelength of 589 nm was then measured using a retardation measurement apparatus (KOBRA 31PR, manufactured by Oji Scientific Instruments) under tensile load applied in the maximum stretching direction (direction in which the stretch ratio reached the maximum) under conditions of 50° C. and 80% RH. The tensile load under which the in-plane retardation R₀ became 0 was determined as “stress under which Δn=0”. Likewise, the birefringence Δn under stress of the film was also measured under conditions of 23° C. and 55% RH.

Measurement of Photoelastic Coefficient c

The retardation R₀ under each tensile load obtained in the preceding measurement of stress under which birefringence Δn under stress became 0 was divided by film thickness d, and Δn (=nx−ny) was calculated to obtain a plot of Δn versus tensile load. The obtained plot was approximated to a straight line, the slope of which was determined as photoelastic coefficient c. The photoelastic coefficient c was calculated both under conditions of 50° C. and 80% RH and under conditions of 23° C. and 55% RH.

Subsequently, polarizing plates and liquid crystal display devices were prepared according to the following methods using polarizer protective films 1 to 11 obtained above.

Preparation of Polarizer

A polyvinyl alcohol film having a thickness of 70 μM was swollen with water of 35° C. The obtained film was immersed for 60 seconds in an aqueous solution consisting of 0.075 g of iodine, 5 g of potassium iodide, and 100 g of water and further immersed in an aqueous solution of 45° C. consisting of 3 g of potassium iodide, 7.5 g of boric acid, and 100 g of water. Then, the obtained film was uniaxially stretched under conditions involving a stretching temperature of 55° C. and a stretch ratio of 5 times. This uniaxially stretched film was washed with water and then dried to obtain a polarizer having a thickness of 20 μm.

Preparation of Adhesive

Components listed below were mixed and then defoamed to prepare a photocurable adhesive solution. Note that triarylsulfonium hexafluorophosphate was prepared as a 50% propylene carbonate solution and indicated below by a solid content.

(Composition of Adhesive Solution)
3,4-Epoxycyclohexylmethyl 3,4-epoxycyclohexanecarboxylate (alicyclic epoxy compound (α)): 45 parts by mass
Epolead GT-301 (manufactured by Daicel Corp., alicyclic epoxy compound (α)): 40 parts by mass
1,4-Butanediol diglycidyl ether (compound (α) substantially free from an alicyclic epoxy group): 15 parts by mass
Triarylsulfonium hexafluorophosphate (cationic photoinitiator (β)): 2.25 parts by mass
9,10-Dibutoxyanthracene (photosensitizer (γ)): 0.1 parts by mass
1,4-Diethoxynaphthalene (photosensitization promoter (δ)): 2.0 parts by mass

Preparation of Polarizing Plate

Each obtained polarizer protective film was surface-treated by corona discharging. Subsequently, the corona discharging-treated surface of the polarizer protective film was coated with the prepared adhesive solution using a bar coater to form an adhesive coating layer having a film thickness (after curing) of approximately 3 μM. The obtained adhesive coating layer was bonded with the polyvinyl alcohol-iodine-based polarizer prepared as mentioned above.

Likewise, KC6UY (manufactured by Konica Minolta Opto, Inc) film was prepared and surface-treated by corona discharging. Subsequently, the corona discharging-treated surface of the film was coated with the prepared adhesive solution using a bar coater to form an adhesive coating layer having a film thickness (after curing) of approximately 3 μm. The obtained adhesive coating layer was bonded with the polarizer having the polarizer protective film bonded to one surface to obtain a laminate of the polarizer protective film/polarizer/KC6UY (manufactured by Konica Minolta Opto, Inc.) film. The polarizer protective film in this laminate was irradiated with UV rays at an integrated quantity of light of 750 mJ/cm² using a UV ray irradiation apparatus (“D Bulb” manufactured by Fusion UV Systems Inc. was used as a lamp) with a belt conveyor to cure the adhesive coating layers. In this way, a polarizing plate containing a polarizer sandwiched between two protective films was prepared.

Preparation of Liquid Crystal Display Device

Each liquid crystal display device including the prepared polarizing plate was prepared as follows: liquid crystal television WO00 W32-L7000 (manufactured by Hitachi, Ltd.), which was a lateral electric field-mode liquid crystal display device, was provided. A liquid crystal cell included in this apparatus had two substrates and a liquid crystal layer disposed therebetween. Only one of these two substrates had a pixel electrode and a counter electrode disposed thereon (IPS type). The liquid crystal cell was disposed so that the substrate having a pixel electrode and a counter electrode disposed thereon was positioned on the backlight side.

A polarizing plate on the backlight side preinstalled in the liquid crystal television WO00 W32-L7000 (manufactured by Hitachi, Ltd.) was detached therefrom, and the prepared polarizing plate was in turn bonded to the glass surface of the liquid crystal cell. This bonding between the prepared polarizing plate and the liquid crystal cell was performed so that the absorption axis of the prepared polarizing plate had the same direction as that of the absorption axis of the preinstalled polarizing plate. Each of polarizer protective films 1 to 11 obtained above was used as the polarizer protective film F3 (polarizer protective film disposed on the surface on the liquid crystal cell side of the polarizer in the polarizing plate on the backlight side) of the liquid crystal display device. Then, egg-shaped blur in the obtained liquid crystal display device was measured.

Evaluation of Egg-Shaped Blur

Each obtained liquid crystal display device was left for 72 hours in a chamber of 50° C. and 80% RH. Then, the liquid crystal display device was taken out of the chamber. The difference between luminance around four corners of the display screen and luminance at and around the center of the display screen (image unevenness) was visually observed in the black-mode state of the liquid crystal display device at ordinary temperature. Light leakage was evaluated according to criteria shown below. A or B was preferred in the evaluation.

A: No image unevenness.

B: Slight image unevenness is confirmed by very careful observation.

C: Image unevenness is confirmed in one of the four corners.

D: Image unevenness is confirmed in two or more of the four corners.

Table 2 shows the results of evaluating the polarizer protective films obtained in Examples and Comparative Example and the results of evaluation of egg-shaped blur in the liquid crystal display devices including the films.

TABLE 2

| | | | | | Stretching | | | | | | Photoelastic | | |
|---|---|---|---|---|---|---|---|---|---|---|---|---|---|
| | | Composition of resin | | | condition | | Optical | | Stress under which | | coefficient c | | |
| | | BR85 | CAP | | | Stretch | property | | nx − ny = 0 [MPa] | | [×10\hat{ }−12 m²/N] | | |
| | Film | [part by | [part by | | Stretching | ratio | R₀ | Rt | 50° C. | 23° C. | 50° C. | 23° C. | egg-shaped |
| | No. | mass] | mass] | Others | direction | [%] | [nm] | [nm] | 80% RH | 55% RH | 80% RH | 55% RH | blur |
| Example 1 | 1 | 70 | 30 | — | T | 5 | −0.3 | −0.3 | 12.3 | 5.9 | 0.6 | 1.3 | A |
| Example 2 | 2 | 70 | 30 | — | T | 10 | −0.8 | −0.5 | 32.7 | 15.8 | 0.6 | 1.3 | A |
| Example 3 | 3 | 75 | 25 | — | T | 10 | 0.4 | −0.8 | 12.7 | 5.8 | −0.8 | 0.2 | A |
| Example 4 | 4 | 75 | 25 | — | T | 20 | 1.0 | −1.0 | 31.8 | 18.4 | −0.8 | 0.2 | A |
| Example 5 | 5 | 90 | 10 | — | M | 20 | 3.1 | −5.0 | 15.6 | 24.3 | −5.0 | −3.2 | A |
| Example 6 | 6 | 80 | 20 | — | M | 10 | 1.5 | −2.8 | 17.2 | 39.0 | −2.2 | −1.0 | B |
| Example 7 | 7 | 60 | 40 | — | M | 10 | −0.8 | 2.9 | 5.9 | 5.7 | 3.4 | 3.5 | A |
| Example 8 | 8 | 60 | 40 | — | M | 30 | −3.3 | 5.1 | 24.2 | 23.6 | 3.4 | 3.5 | A |
| Example 9 | 9 | — | — | Lactone | — | — | 1.6 | −2.9 | 33.3 | 36.4 | −1.2 | −1.1 | B |
| | | | | acrylic | | | | | | | | | |
| Example 10 | 10 | — | — | Lactone | — | — | 0.3 | −1.8 | 12.5 | 15.0 | −0.6 | −0.5 | A |
| | | | | acrylic | | | | | | | | | |
| Comparative | 11 | — | — | Z-TAC | | | −1 | −2.7 | 2.5 | 2.6 | 9.9 | 9.5 | D |
| Example 1 | | | | | | | | | | | | | |

As is evident from the table, the polarizer protective films of Examples 1 to 10 have a birefringence Δn under stress of 0 within the range of 5 to 35 MPa under conditions of 50° C. and 80% RH, and none of the liquid crystal display devices including the films generate egg-shaped blur. By contrast, as is also evident, the polarizer protective film of Comparative Example 1 has a birefringence Δn under stress of 0 under tensile stress lower than 5 MPa under conditions of 50° C. and 80% RH, and the liquid crystal display device including the film generates egg-shaped blur.

The present application claims the priority based on Japanese Patent Application No. 2011-111803 filed on May 18, 2011, the entire contents of which including the claims, specification and drawings are incorporated herein by reference.

### INDUSTRIAL APPLICABILITY

The present invention can limit the generation of egg-shaped blur in a liquid crystal display device (particularly, an IPS-type liquid crystal display device) even under hot and humid conditions.

### REFERENCE SIGNS LIST

10 Liquid crystal display device
20 Liquid crystal cell
40 First polarizing plate
42 First polarizer
44 Polarizer protective film F1
46 Polarizer protective film F2
60 Second polarizing plate
62 Second polarizer
64 Polarizer protective film F3
66 Polarizer protective film F4
80 Backlight

1. A polarizer protective film having a birefringence (nx−ny) under stress of 0, where nx represents a refractive index in X-axis direction in which an in-plane birefringence of the film is maximized, and ny represents a refractive index in Y-axis direction orthogonally intersecting the X-axis direction in the plane of the film,
wherein the birefringence (nx−ny) under stress is measured at a wavelength of 589 nm under any tensile stress of 5 MPa to 35 MPa applied in the X-axis direction or the Y-axis direction of the film under conditions of 50° C. and 80% RH.

2. The polarizer protective film according to claim 1, wherein under conditions of 50° C. and 80% RH in the absence of tensile stress, the film has in-plane retardation R₀(589) in the range of −3 nm to +3 nm at a wavelength of 589 nm and thickness retardation Rt(589) in the range of −3 nm to +3 nm at a wavelength of 589 nm, the in-plane retardation R₀(589) and the thickness retardation Rt(589) being represented by Equations (I) and (II), respectively:
R₀(589)=(nx−ny)×d, Equation (I):
and
Rt(589)={(nx+ny)/2−nz}×d, Equation (II):
where d represents a thickness (nm) of the film; nx represents a refractive index in the X-axis direction in which the in-plane birefringence of the film is maximized; ny represents a refractive index in the Y-axis direction orthogonally intersecting the X-axis in the plane of the film; and nz represents a refractive index in a thickness direction of the film.

3. The polarizer protective film according to claim 1, wherein the film has a photoelastic coefficient of −3.0×10⁻¹² to 3.0×10⁻¹² m²/N under conditions of 50° C. and 80% RH.

4. The polarizer protective film according to claim 1, wherein the film has a birefringence (nx−ny) under stress of 0, the birefringence (nx−ny) under stress being measured at a wavelength of 589 nm under any tensile stress of 5 MPa to 35 MPa applied in the X-axis direction or the Y-axis direction of the film under conditions of 23° C. and 55% RH.

5. The polarizer protective film according to claim 1, wherein the film comprises an acrylic resin and a cellulose ester.

6. The polarizer protective film according to claim 5, wherein a mass ratio of the acrylic resin and to the cellulose ester (acrylic resin/cellulose ester) is 90/10 to 30/70.

7. The polarizer protective film according to claim 5, wherein the cellulose ester has a total degree of acyl substitution of 2 to 3 and a degree of C₃₋₇ acyl substitution of 2 to 3.

8. The polarizer protective film according to claim 6, wherein the cellulose ester has a total degree of acyl substitution of 2 to 3 and a degree of C₃₋₇ acyl substitution of 2 to 3.

9. A polarizing plate comprising:
a polarizer; and
the polarizer protective film according to claim 1 disposed on at least one surface of the polarizer.

10. A liquid crystal display device comprising, in order from the viewing side:
a first polarizing plate;
a liquid crystal cell;
a second polarizing plate; and
a backlight,
wherein the liquid crystal cell includes first and second opposing substrates, the first substrate having a pixel electrode and a counter electrode disposed thereon, and a liquid crystal layer sandwiched between the first and second substrates, the liquid crystal layer including liquid crystal molecules oriented horizontally to a surface of the first substrate during voltage is not applied,
the first polarizing plate includes a first polarizer and a polarizer protective film F2 disposed on a surface on a liquid crystal cell side of the first polarizer,
the second polarizing plate includes a second polarizer and a polarizer protective film F3 disposed on a surface on the liquid crystal cell side of the second polarizer, and
at least one of the polarizer protective films F2 and F3 is the polarizer protective film according to claim 1.

11. A liquid crystal display device comprising, in order from the viewing side:
a first polarizing plate;
a liquid crystal cell;
a second polarizing plate; and a backlight,
wherein the liquid crystal cell includes first and second opposing substrates, the first substrate having a pixel electrode and a counter electrode disposed thereon, and a liquid crystal layer sandwiched between the first and second substrates, the liquid crystal layer including liquid crystal molecules oriented horizontally to a surface of the first substrate during voltage is not applied,
the first polarizing plate includes a first polarizer and a polarizer protective film F2 disposed on a surface on a liquid crystal cell side of the first polarizer,
the second polarizing plate includes a second polarizer and a polarizer protective film F3 disposed on a surface on the liquid crystal cell side of the second polarizer, and
at least one of the polarizer protective films F2 and F3 is the polarizer protective film according to claim 5.

12. A liquid crystal display device comprising, in order from the viewing side:
a first polarizing plate;
a liquid crystal cell;
a second polarizing plate; and
a backlight,
wherein the liquid crystal cell includes first and second opposing substrates, the first substrate having a pixel electrode and a counter electrode disposed thereon, and a liquid crystal layer sandwiched between the first and second substrates, the liquid crystal layer including liquid crystal molecules oriented horizontally to a surface of the first substrate during voltage is not applied,
the first polarizing plate includes a first polarizer and a polarizer protective film F2 disposed on a surface on the liquid crystal cell side of the first polarizer,
the second polarizing plate includes a second polarizer and a polarizer protective film F3 disposed on a surface on the liquid crystal cell side of the second polarizer, and
at least one of the polarizer protective films F2 and F3 is the polarizer protective film according to claim 8.

13. The liquid crystal display device according to claim 10, wherein at least one of the polarizer protective films F2 and F3 comprises a lactone ring-containing polymer.

14. A liquid crystal display device comprising, in order from the viewing side:
a first polarizing plate;
a liquid crystal cell;
a second polarizing plate; and
a backlight,
wherein the liquid crystal cell includes first and second opposing substrates, the first substrate having a pixel electrode and a counter electrode disposed thereon, and a liquid crystal layer sandwiched between the first and second substrates, the liquid crystal layer including liquid crystal molecules oriented horizontally to a surface of the first substrate during voltage is not applied,
the first polarizing plate includes a first polarizer and a polarizer protective film F2 disposed on a surface on the liquid crystal cell side of the first polarizer,
the second polarizing plate includes a second polarizer and a polarizer protective film F3 disposed on a surface on the liquid crystal cell side of the second polarizer, and
the polarizer protective film F3 is the polarizer protective film according to claim 5.

15. The liquid crystal display device according to claim 10, wherein the polarizer protective film F3 comprises a lactone ring-containing polymer.
